(19) United States
(12) Patent Application Publication
(10) Pub. No.: US 2022/0076180 A1
(43) Pub. Date: Mar. 10, 2022

(54) RESOURCE MANAGEMENT APPARATUS, RESOURCE MANAGEMENT SYSTEM, RESOURCE MANAGEMENT PROGRAM

(71) Applicant: Ryoh TOMOSUGI, Kanagawa (JP)

(72) Inventor: Ryoh TOMOSUGI, Kanagawa (JP)

(73) Assignee: Ricoh Company, Ltd., Tokyo (JP)

(21) Appl. No.: 17/446,878

(22) Filed: Sep. 3, 2021

(30) Foreign Application Priority Data
Sep. 9, 2020 (JP) 2020-151665

(51) Int. Cl. G06Q 10/06; G06Q 10/02

(52) U.S. Cl. CPC G06Q 10/06314; G06Q 10/02

(57) ABSTRACT

A resource management server executes a determination of whether reservation can be extended as to whether a reserved resource can be extended based on a reservation status beyond reservation end date and time of a predetermined resource, and as a response of a result of a reservation, transmits information for displaying “EXTENSION” when a reservation extension is “OK” or transmits information for displaying “MOVEMENT” when a reservation extension is “N/A” to information processing terminal.

### CROSS-REFERENCE TO RELATED APPLICATIONS

The present application claims priority under 35 U.S.C. § 119 to Japanese Patent Application No. 2020-151665, filed on Sep. 9, 2020, the entire contents of which are incorporated herein by reference.

### BACKGROUND OF THE INVENTION

### 1. Field of the Invention

The disclosures herein relate to a resource management apparatus, a resource management system, a resource management method, and a program.

### 2. Description of the Related Art

A technique for displaying information related to a resource reservation of a resource such as a meeting room used in schools, offices, or the like by an information processing terminal arranged or installed in a resource is known. As a result, a user can input start of use into the information processing terminal to start using the resource, and the user can input end of use into the information processing terminal when the user is finished using the resource.

On the other hand, it is disclosed that if it is estimated that a user for the room will not leave within a reserved time, and a reservation for the next time period does not satisfy a predetermined condition (for example, whether there is more than a predetermined amount of free time before the next reservation is started.), a candidate for another room available for reservation is presented (see Patent Document 1, for example).

However, in the related-art, regardless of whether or not a time extension can be made, the option to extend the resource or to reserve another room may become unavailable, making it difficult to use the resource extension reservation.

### RELATED-ART DOCUMENTS

### Patent Documents

Patent Document 1: Japanese Laid-Open Patent Application No. 2019-079404

### SUMMARY OF THE INVENTION

It is a general object of the described embodiments to provide a resource reservation system that provides an information processing terminal shared by a plurality of resources.

According to at least one embodiment a resource management apparatus managing a resource, the resource management apparatus comprising includes one or more memories and one or more processing circuits coupled to the one or more memories and configured to function as a receiver configured to receive reservation information related to a reservation of a resource transmitted by a reservation management device managing the reservation of the resource, and a transmitter configured to transmit predetermined reservation information updated for a reservation of a predetermined resource to an information processing terminal operated by a user of the predetermined resource, wherein upon determination that the predetermined resource is available for continued reservation beyond a reservation end date and time of the predetermined resource currently in use, the transmitter transmits, to the information processing terminal, extension selection information for prompting a selection of whether to extend a use of the predetermined resource, wherein upon determination that the predetermined resource is not available for continued reservation beyond the reservation end date and time, the transmitter transmits, to the information processing terminal, movement selection information for prompting a selection of whether to move from the predetermined resource to another resource, wherein the determination is made based on a reservation status following the reservation end date and time obtained by comparing the reservation information received by the receiver with reservation end date and time information indicating the reservation end date and time of the predetermined resource currently in use.

### BRIEF DESCRIPTION OF THE DRAWINGS

Other objects and further features of the present invention will be apparent from the following detailed description when read in conjunction with the accompanying drawings, in which:

FIG. 1 is a diagram illustrating an example of an overall configuration of a communication system according to a present embodiment;

FIG. 2 is a diagram illustrating an example of a hardware configuration of an information processing terminal according to the present embodiment;

FIG. 3 is a diagram illustrating an example of hardware configurations of a resource management server and a reservation management server according to the present embodiment;

FIG. 4 is a diagram illustrating an example of a functional configuration of the communication system according to the present embodiment;

FIG. 5 is a conceptual diagram illustrating an example of a tenant table according to the present embodiment;

FIG. 6 is a conceptual diagram illustrating an example of a reservation information management table according to the present embodiment;

FIG. 7 is a conceptual diagram illustrating an example of a resource information management table according to the present embodiment;

FIG. 8 is a conceptual diagram illustrating an example of an extension movement management table according to the present embodiment;

FIG. 9 is a conceptual diagram illustrating an example of a schedule management table according to the present embodiment;

FIG. 10 is a sequence diagram illustrating an example of schedule information acquisition and resource usage start processing according to the present embodiment;

FIG. 11 is a sequence diagram illustrating an example of periodic update processing of reservation information according to the present embodiment;

FIG. 12 is a flowchart illustrating an example of a determination of resource extension availability according to the present embodiment;

FIG. 13 is a sequence diagram illustrating an example of extension and movement of the resource according to the present embodiment;

FIG. 14 is a sequence diagram illustrating an example of selection processing of a candidate resource for a movement destination according to the present embodiment;

FIG. 15 is a flowchart illustrating an example of determination processing of selection availability of candidate resource for the movement destination according to the present embodiment;

FIG. 16 is a sequence diagram illustrating an example of display processing of a candidate resource for a movement destination according to the present embodiment;

FIG. 17 is a sequence diagram illustrating an example of reservation update processing of movement destination resource according to the present embodiment;

FIG. 18 is a diagram illustrating an example of a vacancy display screen of an information processing terminal according to the present embodiment;

FIG. 19 is a diagram illustrating an example of a waiting for entry display screen of the information processing terminal according to the present embodiment;

FIG. 20 is a diagram illustrating an example of an extension display screen of the information processing terminal according to the present embodiment;

FIG. 21 is a diagram illustrating an example of a display screen during extension of the information processing terminal according to the present embodiment;

FIG. 22 is a diagram illustrating an example of a movement display screen of the information processing terminal according to the present embodiment;

FIG. 23 is a diagram illustrating an example of a candidate for movement destination display screen of the information processing terminal according to the present embodiment;

FIG. 24 is a diagram illustrating an example of a display screen when there is no candidate for movement destination of the information processing terminal according to the present embodiment; and

FIG. 25 is a diagram illustrating an example of another waiting for entry display screen of the information processing terminal according to the present embodiment.

### DESCRIPTION OF THE EMBODIMENTS

Hereinafter, an embodiment of the present invention will be described with reference to the drawings. In the description of the drawings, the same elements are designated by the same reference numerals, and duplicate descriptions will be omitted.

### Embodiment

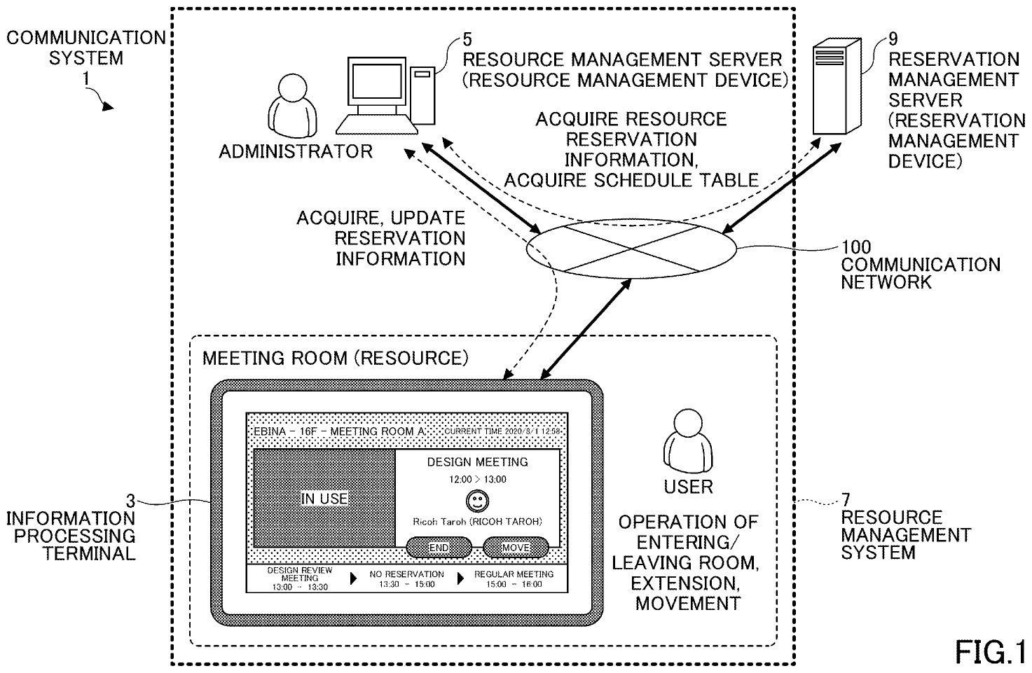

First, the present embodiment will be described with reference to FIG. 1 to FIG. 25.

[Overview of Communication System]

FIG. 1 is a diagram illustrating an example of an overall configuration of a communication system according to a present embodiment. In a communication system 1 illustrated in FIG. 1, a resource management server 5 periodically acquires reservation information related to a reservation of each resource from a reservation management server 9 that manages the reservation of each resource such as a meeting room and the schedule of the user. Further, in the communication system 1, an information processing terminal 3 arranged or installed in each resource displays a latest status of each resource based on the reservation information related to the reservation of each resource acquired by the resource management server 5. This allows the user who uses each resource, with the information processing terminal 3, to perform an entering/leaving operation for each resource, an extension operation for each resource, a move operation for moving to another resource, and the like. The information processing terminal 3 may be a portable terminal such as a mobile terminal owned by an individual. Therefore, the information processing terminal 3 is not required to be arranged or installed in the resource. In that case, the information processing terminal 3 and the resource may be temporarily or permanently correlated.

In the present embodiment, the communication system 1 includes the information processing terminal 3, the resource management server 5, and the reservation management server 9. Further, the information processing terminal 3, the resource management server 5, and the reservation management server 9 are connected to each other via a communication network 100. The communication network 100 is configured by the Internet, a mobile communication network, a LAN (Local Area Network), or the like. The communication network 100 may include not only wired communication but also wireless communication networks such as 3G (3rd Generation), 4G (4th Generation), 5G (5th Generation), WiMAX (Worldwide Interoperability for Microwave Access), LTE (Long Term Evolution), or the like. Further, the resource management server 5 in the present embodiment may include a meeting management server for operating dedicated application software (hereinafter referred to as a meeting application) related to a predetermined event such as a meeting. Further, the application described above may be substituted by browser software. Further, in the present embodiment, the information processing terminal 3 and the resource management server 5 may be connected via the communication network 100 to be configured as a resource management system 7.

«Information Processing Terminal»

The information processing terminal 3 is a communication terminal equipped with such a general OS. The information processing terminal 3 is used by a user of each tenant of such as a school, a company, a group, and an organization, and is arranged or installed in each resource such as a meeting room. Further, the information processing terminal 3 is operated before a resource reservation start date and time, during reservation, after a reservation end date and time, by the user who uses the resource, the user who made the reservation, or the like. Further, the information processing terminal 3 may be a communication terminal with communication functions, such as a smartphone, a tablet terminal, a Personal Computer (PC), a Personal Digital Assistant (PDA), a wearable PC (e.g., sunglasses type, wristwatch type). That is, a terminal capable of operating software such as browser software may be used as the communication terminal.

Further, a plurality of information processing terminals 3 may exist in the communication system 1. That is, the information processing terminal 3 may be arranged or installed in each resource. Therefore, when a user of a certain resource tries to search for a candidate for another resource, a reservation conflict for another resource may occur with the other user. In consideration of the above, the reservation conflict is controlled so as not to occur by managing each data table managed by the resource management server 5 described later. In the present embodiment, the information processing terminal 3 functions as an example of an information processing terminal.

«Resource Management Server»

The resource management server 5 can be implemented by one or more information processing devices (computer systems) equipped with a general server OS, for example. The resource management server 5 is used by an administrator (system administrator) who manages a resource such as a meeting room used by each tenant such as a school, a company, a group, and an organization. The resource management server 5 manages and updates the resource reservation or schedule. Further, the resource management server 5 can manage check-in (entering) and check-out (leaving) to/from each resource, or control a power supply of an electronic device provided in each resource based on the reservation information related to the reservation of each resource obtained from the reservation management server 9. In the present embodiment, the resource management server 5 functions as an example of a resource management apparatus.

«Reservation Management Server»

The reservation management server 9 is implemented by one or more information processing devices (computer systems) equipped a general server OS, for example. The reservation management server 9 includes a calendar system, and provides a web application configured to manage the resource reservation and various schedules of the user who uses the resource. For example, the reservation management server 9 includes the following functions.
Accepting a registration of a reservation or a schedule of the user, and confirming the reservation status or the schedule of the user from anywhere at anytime
Notifying the user by e-mail at a set date and time, such as 30 minutes before the schedule
Managing a reservation or a schedule with multiple calendars (for work, for home, etc.) by one person
Sharing the calendar with a user of the same group The reservation management server 9 manages the user with an account. The account is a user's right to use a service. In many systems, the user logs in to the system with the account. Therefore, the account includes a function in which the system uniquely identifies the user (identification information function). In the present embodiment, the reservation management server 9 transmits reservation information of the account (domain) registered in advance to the meeting management server configured to manage the meeting room, for example. Alternatively, the meeting management server may request the reservation information by specifying the account of the reservation management server 9 so that the meeting management server can acquire the reservation information of the meeting room from the reservation management server 9. Note that the account may be any information that can uniquely identify the user, such as an e-mail, an ID, or a telephone number.

In the present embodiment, the reservation management server 9 can manage the schedule of the user who reserves various resources, including the meeting room. Examples of a reservation management server 20 include G Suite (registered trademark) and Office 365 (registered trademark). However, any reservation management system including the functions described in the present embodiment may be used.

Further, in the present embodiment, information related to the various resources by each user and the schedule of the user is preregistered in the reservation management server 9. That is, the web application of the reservation management server 9 is customized according to a meeting room name, a meeting room ID, an available reservation time, a capacity, and a reservation unit of each meeting room in the internal network of the company that uses the communication system 1. Therefore, the reservation information is associated with the resource including the meeting room of the company that uses the communication system 1. In the present embodiment, the reservation management server 9 functions as an example of a reservation management device.

<Terms>

The term “resource” as used herein refers to a resource owned, rented, or managed by a school, a company, a group, an organization, or the like. The resource of the school, the company, the association, or the organization, for example, may be the meeting room, or an equipment, a device, or a person (reception group) that can be used/utilized in the meeting room. Further, a space such as a free space with a free address (hereinafter referred to as free space), a desk, a chair, and a booth, a company car, a bicycle, a parking lot, a bicycle parking lot, a teleconferencing system, and a printing service or mechanism may be a resource. A facility refers to the resource that is difficult to move. In the present embodiment, for convenience of description, the meeting room is used as an example of the resource. Further, as an example of the resource, various electronic devices, a space such as a rental office and a rental studio, a rental cycle, a rental car (car sharing), an accommodation such as a hotel, a rental space or place such as an event hall, a locker may be used as a resource.

The user is a person who reserves or uses the resource such as the free space or the meeting room. The user operates the information processing terminal 3 to perform the entering/leaving processing of the reserved resource, the extension processing of the reservation, the movement processing accompanying the extension of the reservation, and the like. The user may be called a participant.

An administrator means a person who uses and manages the resource management server 5 in the present embodiment.

[Hardware Configuration]

<Hardware Configuration of Information Processing Terminal>

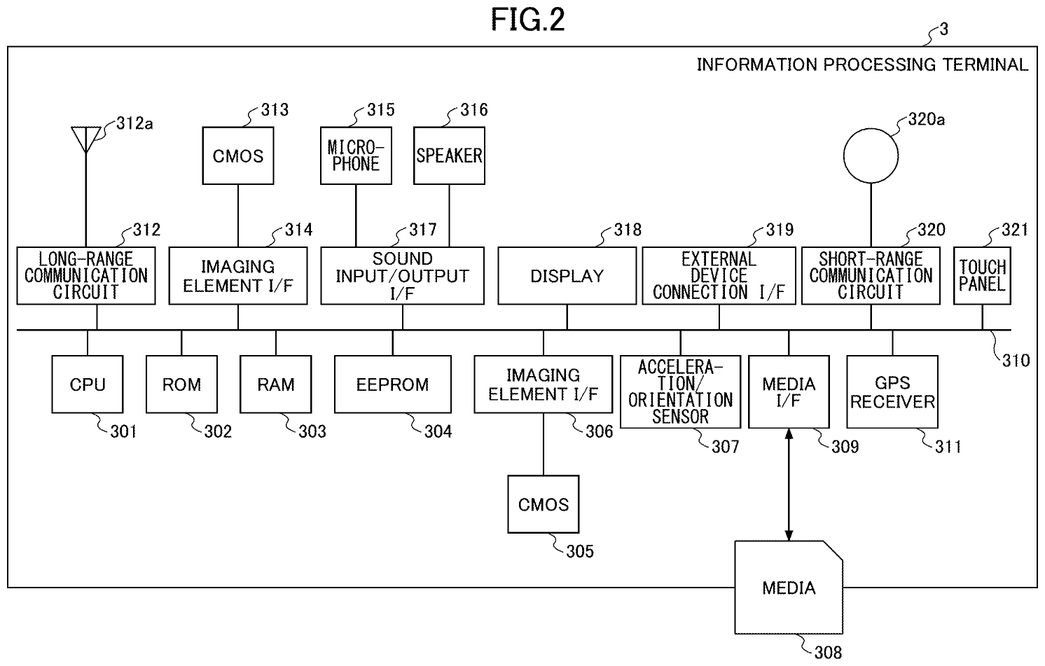

FIG. 2 is a diagram illustrating an example of a hardware configuration of the information processing terminal according to the present embodiment. The information processing terminal 3 is configured by a computer. As illustrated in FIG. 2, the information processing terminal 3 includes a CPU 301, a read-only memory (ROM) 302, a random-access memory (RAM) 303, an electrically erasable programmable read-only memory (EEPROM) 304, a complementary metal-oxide semiconductor (CMOS) sensor 305, an imaging element interface (I/F) 306, an acceleration/orientation sensor 307, and a media I/F 309, and a GPS receiver 311.

The CPU 301 controls the overall operation of the information processing terminal 3. The ROM 302 stores a program used to drive the CPU 301, such as an IPL. The RAM 303 is used as a work area for the CPU 301. The EEPROM 304 reads and writes various data such as applications according to the control of the CPU 301. The CMOS sensor 305 is a type of built-in imaging unit that captures a subject (mainly an image of a user himself/herself) according to the control of the CPU 301 to acquire image data or moving image data. Note that the imaging unit may be any other imaging unit such as a charge-coupled device (CCD) sensor, instead of a CMOS sensor. The imaging element I/F 306 is a circuit that controls the driving of the CMOS sensor 305. The acceleration/orientation sensor 307 is a sensor that detects the geomagnetic field, such as an electromagnetic compass, a gyrocompass, or an acceleration sensor. The media I/F 309 controls the reading and writing (storage) of data from and to a recording media 308 such as a flash memory. The GPS receiver 311 receives a GPS signal from a GPS satellite.

Further, the information processing terminal 3 includes a long-range communication circuit 312, an antenna 312a of the long-range communication circuit 312, a CMOS sensor 313, an imaging element I/F 314, a microphone 315, a speaker 316, a sound input/output I/F 317, a display 318, an external device connection I/F 319, a short-range communication circuit 320, an antenna 320a of the short-range communication circuit 320, and a touch panel 321.

The long-range communication circuit 312 is a circuit that communicates with other devices via a communication network 100. The CMOS sensor 313 is a type of built-in imaging unit that captures a subject according to the control of the CPU 301 to acquire image data. The imaging element I/F 314 is a circuit that controls the driving of the CMOS sensor 313. The microphone 315 is a built-in circuit that converts sound to an electrical signal, acquires sound and sound waves from external speakers to acquire information using electrical signals. The speaker 316 is a built-in circuit that converts an electrical signal into physical vibrations to produce sounds, such as music and speech. The sound input/output I/F 317 is a circuit that processes the input and output of a sound signal between the microphone 315 and the speaker 316 according to the control of the CPU 301. The display 318 is a type of display units such as a liquid crystal display or an organic electroluminescence (EL) display that displays an image of a subject, various icons, and the like. The external device connection I/F 319 is an interface for connecting various external devices. The short-range communication circuit 320 is a communication circuit such as near-field communication (NFC) or Bluetooth (registered trademark). The touch panel 321 is a type of input unit for operating the information processing terminal 3 by a user's operation such as pressing, clicking, tapping on the display 318. Note that each of the CMOS sensor 313, the short-range communication circuit 320, the microphone 315, or the like is an information acquisition unit that acquires identification information of the resource, for example, by an image (such as an image code), a wireless communication, and a sound wave.

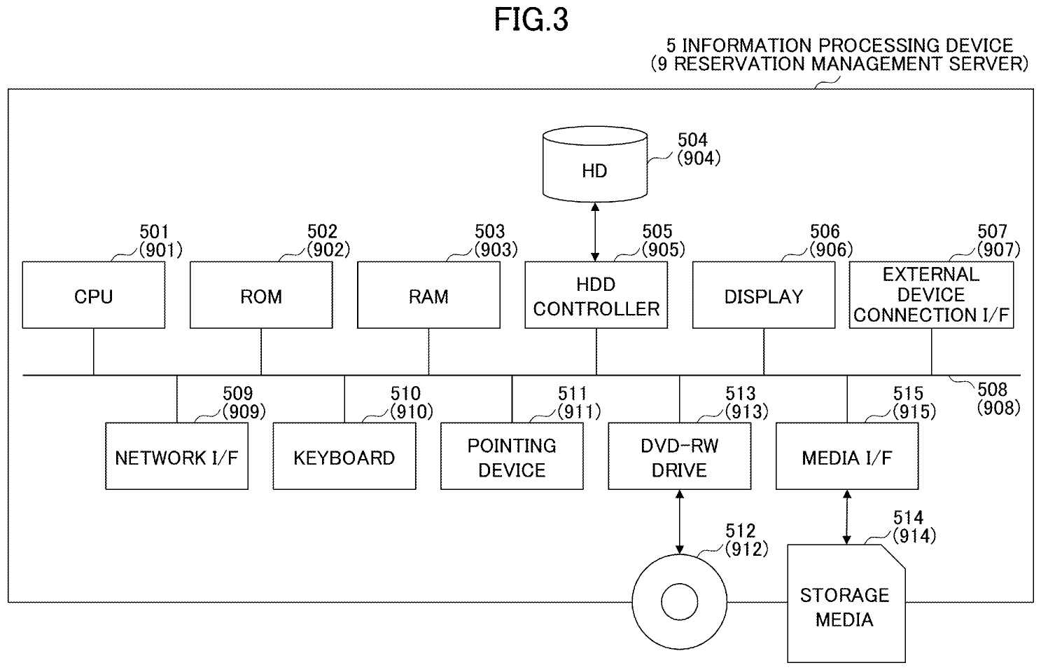

In addition, the information processing terminal 3 includes a bus line 310. The bus line 310 is an address bus, data bus, or the like for electrically connecting components such as the CPU 301 illustrated in FIG. 3.

<Hardware Configuration of Resource Management Server and Reservation Management Server>

FIG. 3 illustrates an example of a hardware configuration of the resource management server and the reservation management server according to the present embodiment. The resource management server 5 and the reservation management server 9 are configured by a computer. As illustrated in FIG. 3, the resource management server 5 and the reservation management server 9 include a CPU 501, a ROM 502, a RAM 503, an HDD 504, a Hard Disk Drive (HDD) controller 505, a display 506, an external device connection interface (I/F) 507, a bus line 508, a network I/F 509, a keyboard 510, a pointing device 511, a digital versatile disk rewritable (DVD-RW) drive 513, and a media I/F 515.

The CPU 501 controls the overall operation of the computer system. The ROM 502 stores a program used to drive the CPU 501, such as an IPL. The RAM 503 is used as a work area for the CPU 501. The HDD 504 stores various data such as a program. The HDD controller 505 controls the reading and writing of various data from and to the HDD 504 according to the control of the CPU 501. The display 506 displays various information such as cursors, menus, windows, characters, or images. The external device connection I/F 507 is an interface for connecting various external devices. In this case, the external device may be a universal serial bus (USB) memory or a printer. The network I/F 509 is an interface for performing data communication using a communication network. The bus line 508 is an address bus, a data bus, or the like for electrically connecting components such as the CPU 501 illustrated in FIG. 3.

The keyboard 510 is a type of input unit having a plurality of keys for inputting characters, numbers, and various instructions. The pointing device 511 is a type of input unit for selecting and executing various instructions, selecting a processing target, and moving a cursor. The DVD-RW drive 513 controls the reading and writing of various data from and to the DVD-RW 512, which is an example of a removable recording medium. The DVD-RW 512 is not limited to a DVD-RW and may be a DVD-R. The media I/F 514 controls the reading and writing (storage) of data from and to a recording medium 414 such as a flash memory.

Further, the reservation management server 9 is configured by a computer. As illustrated in FIG. 3, the reservation management server 9 includes a CPU 701, a ROM 702, a RAM 703, an HDD 704, an HDD controller 705, a display 706, an external device connection interface (I/F) 707, a bus line 708, a network I/F 709, a keyboard 710, a pointing device 711, a DVD-RW drive 713, and a media I/F 715. These configurations are the same configurations as the CPU 501, the ROM 502, the RAM 503, the HDD 504, the HDD controller 505, the display 506, the external device connection interface (I/F) 507, the bus line 508, the network I/F 509, the keyboard 510, the pointing device 511, the digital versatile disk rewritable (DVD-RW) drive 513, and the media I/F 515 of the resource management server 5, so the description is omitted.

Note that each of the programs may be a file in an installable format or an executable format, and may be recorded and distributed on a computer-readable recording medium. An example of the recording medium includes such as a Compact Disc Recordable (CD-R), a Digital Versatile Disk (DVD), a Blu-ray Disc, an SD card, a USB memory. Further, the recording medium can be provided domestically or internationally as a Program Product. For example, the resource management server 5 implements the resource management method according to the present invention by executing the program according to the present invention.

[Functional Configuration of Communication System]

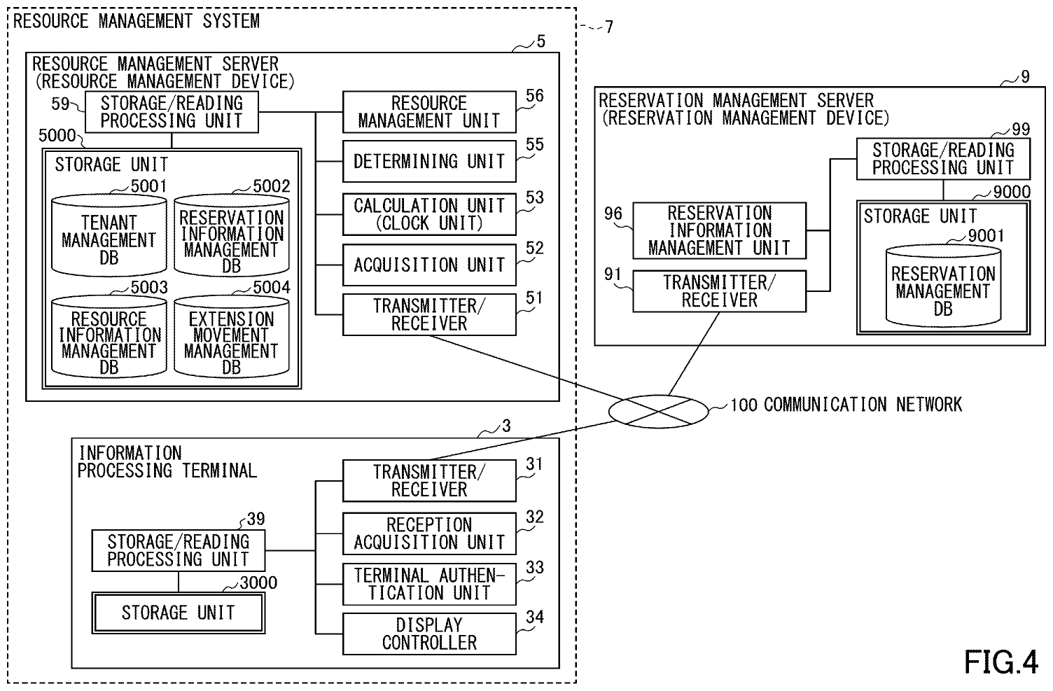

Next, a functional configuration of the present embodiment will be described with reference to FIG. 4 to FIG. 9. FIG. 4 is a diagram illustrating an example of the functional configuration of the communication system according to the present embodiment.

<Functional Configuration of Information Processing Terminal>

As illustrated in FIG. 4, the information processing terminal 3 includes a transmitter/receiver 31, a reception acquisition unit 32, a terminal authentication unit 33, a display controller 34, and a storage/reading processing unit 39. Each of these units is a function or a unit implemented by an operation, of any one of the configurations illustrated in FIG. 2, according to an instruction from the CPU 301 according to a program for the information processing terminal 3 deployed on the RAM 303 from the ROM 302, the EEPROM 304, or both.

In addition, the information processing terminal 3 includes a storage unit 3000 configured by the ROM 302 or the EEPROM 304 illustrated in FIG. 2.

«Each Functional Configuration of Information Processing Terminal»

Next, each functional configuration of the information processing terminal 3 will be described in detail. The transmitter/receiver 31 of the information processing terminal 3 illustrated in FIG. 4 is mainly implemented by processing of the CPU 301, and by the long-range communication circuit 312 and the external device connection I/F 319, illustrated in FIG. 2. The transmitter/receiver 31 of the information processing terminal 3 transmits and receives various data (or information) to and from the resource management server 5 via the communication network 100.

The reception acquisition unit 32 is mainly implemented by the processing of the CPU 301 and the processing of a touch panel 321 illustrated in FIG. 2. The reception acquisition unit 32 receives a user's selection or input of an operation button provided on the touch panel 321 or an icon displayed on the touch panel 321.

The terminal authentication unit 33 is mainly implemented by the processing of the CPU 301 illustrated in FIG. 2. The terminal authentication unit 33 authenticates the user in the login process to the information processing terminal 3, for example, based on whether the entered password is correct or not.

The display controller 34 is mainly implemented by the processing of the CPU 301, and by the display 318 and the touch panel 321 illustrated in FIG. 2. The display controller 34 controls the display 318 or the touch panel 321 to display various images, characters, code information, and the like. In the present embodiment, the display controller 34 includes a function as an example of the display controller.

The storage/reading processing unit 39 is mainly implemented by the processing of the CPU 301 illustrated in FIG. 2. The storage/reading processing unit 39 stores various data (or information) in the storage unit 3000, and reads various data (or information) from the storage unit 3000.

The information processing terminal 3 mainly performs the following processing by each function or each functional unit described above.
Requesting the resource management server 5 for reservation information related to the resource reservation associated with the information processing terminal 3 at predetermined intervals
Requesting the resource management server 5 to perform corresponding processing when the user using the resource performs various operations such as entering/leaving the resource, extending the reservation, and movement

<Functional Configuration of Resource Management Server>

As illustrated in FIG. 4, the resource management server 5 includes a transmitter/receiver 51, an acquisition unit 52, a calculation unit (clock unit) 53, a determination unit 55, and a storage/reading processing unit 59. Each of these functional units is a function or a unit implemented by an operation, of any one of the configurations illustrated in FIG. 3, according to an instruction from the CPU 501 according to a program for the resource management server 5 deployed on the RAM 503 from the ROM 502, the HDD 504, or both. Further, the resource management server 5 includes a storage unit 5000 configured by the ROM 502 or HDD 504 illustrated in FIG. 3.

(Tenant Management Table)

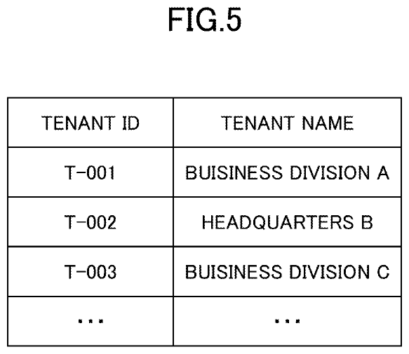

FIG. 5 is a conceptual diagram illustrating an example of a tenant table according to the present embodiment. The tenant management DB 5001 including a tenant management table as illustrated in FIG. 5 is configured in the storage unit 5000. The tenant management table stores and manages a tenant name associated with each tenant ID.

The tenant ID is identification information for identifying the tenant (borrower), and is, for example, T-001, T-002, T-003, or the like. The tenant name is a name of the tenant corresponding to the tenant ID, and is, for example, Business division A, Headquarters B, Business division C, and the like. Note that the ID is an abbreviation for identification and means an identifier or identification information. Further, the ID refers to a name, a code, a character string, a numerical value, or a combination of one or more of these, which is used to uniquely distinguish a specific object from a plurality of objects.

Hereinafter, the same applies to IDs other than tenant IDs.

(Reservation Information Management Table)

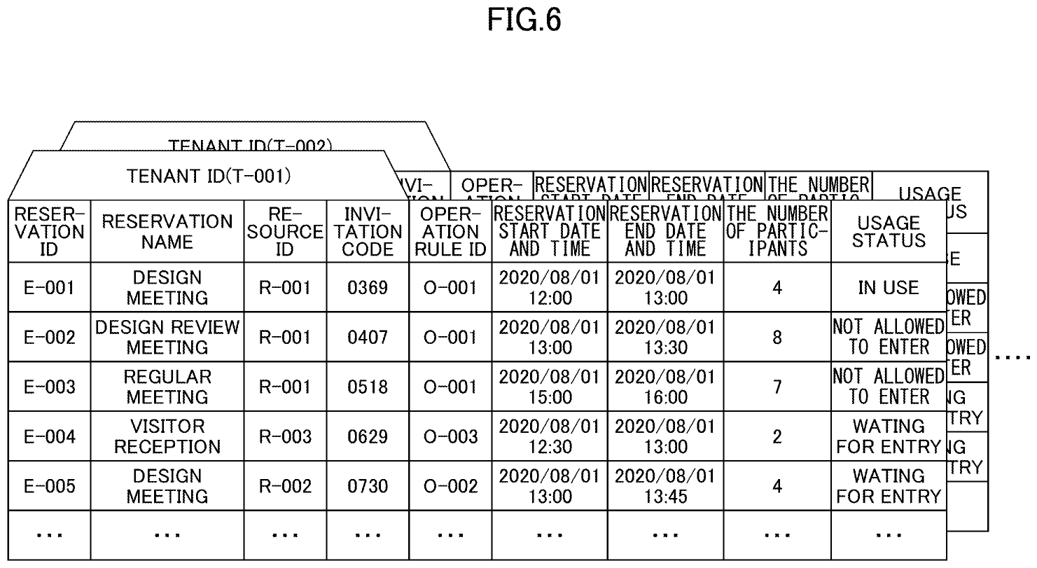

FIG. 6 is a conceptual diagram illustrating an example of a reservation information management table according to the present embodiment. A reservation information management DB 5002 including a reservation information management table as illustrated in FIG. 6 is configured in the storage unit 5000. In the reservation information management table, the tenant ID described above used as a tab, and a reservation name, a resource ID, an invitation code, an operation rule ID, a reservation start date and time, a reservation end date and time, the number of participants, and usage status are stored and managed in association with each reservation ID divided by each tab.

The reservation ID is identification information for identifying one record of the reservation information, and is, for example, E-001, E-002, E-003, E-004, E-005, or the like.

The reservation name indicates a content of an event held in the resource such as a reserved meeting room, and is, for example, a design meeting, a design review meeting, a regular meeting, a visitor reception, or the like.

The resource ID is identification information for identifying a resource such as the reserved conference room, and is, for example, R-001, R-002, R-003, or the like.

The invitation code is code information sent in advance by, for example, an e-mail from the resource management server 5 to a user who reserved the resource such as a meeting room. The invitation code is determined in association with the reservation content. That is, the invitation code may be associated with the e-mail address of the user who reserved the resource. In the present embodiment, the invitation code is given information indicated by a four-digit number.

The operation rule ID is identification information for identifying a purpose of use of the resource to be reserved. Details will be described in the extension movement management table.

The reservation start date and time is the point in time at which the reservation content is started (the date and time when the reservation content starts), and the reservation end date and time is the point in time at which the reservation content is to be finished (the date and time when the reservation content ends). The number of participants is the number of participants participating in the event with the reserved name being performed on the reserved resource.

The usage status indicates a current status of the resource indicated by the resource ID, and for example, a status such as “in use”, “not allowed to enter”, or “waiting for entry” is given.

In the present embodiment, the reservation information management table (reservation information management DB 5002) functions as an example of the reservation information management unit.

(Resource Information Management Table)

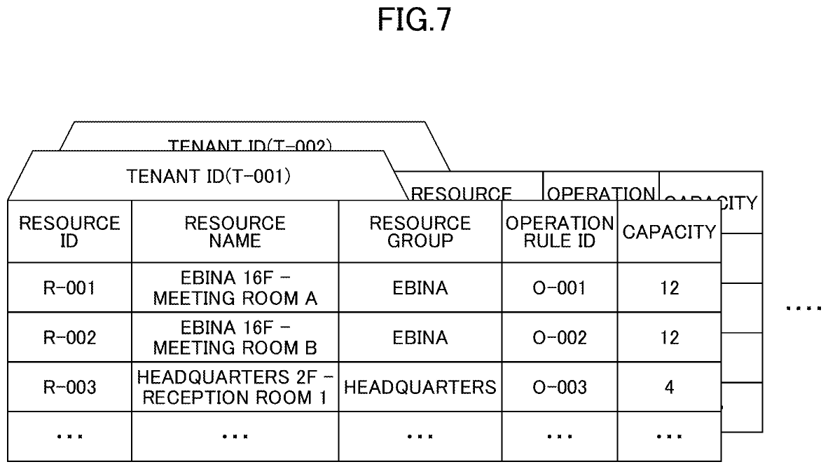

FIG. 7 is a conceptual diagram illustrating an example of a resource information management table according to the present embodiment. A resource information management DB 5003 including a resource information management table as illustrated in FIG. 7 is configured in the storage unit 5000. In the resource information management table, the tenant ID described above is used as a tab, and a resource name, a resource group, an operation rule ID, and a capacity are stored and managed in association with each resource ID divided by each tab.

The resource name represents a name of the resource associated with the resource ID, and is, for example, Ebina 16F—Meeting Room A, Headquarters 2F—Reception Room 1, and the like. Further, the resource group indicates a place where a resource exists and is managed, such as Ebina, Headquarters.

The operation rule ID is identification information for identifying a purpose of use of the resource to be reserved. Details will be described in the extension movement management table. The capacity indicates a maximum number of people that can be accommodated in the resource.

In the present embodiment, the resource information management table (resource information management DB 5003) functions as an example of the resource information management unit.

(Extension Movement Management Table)

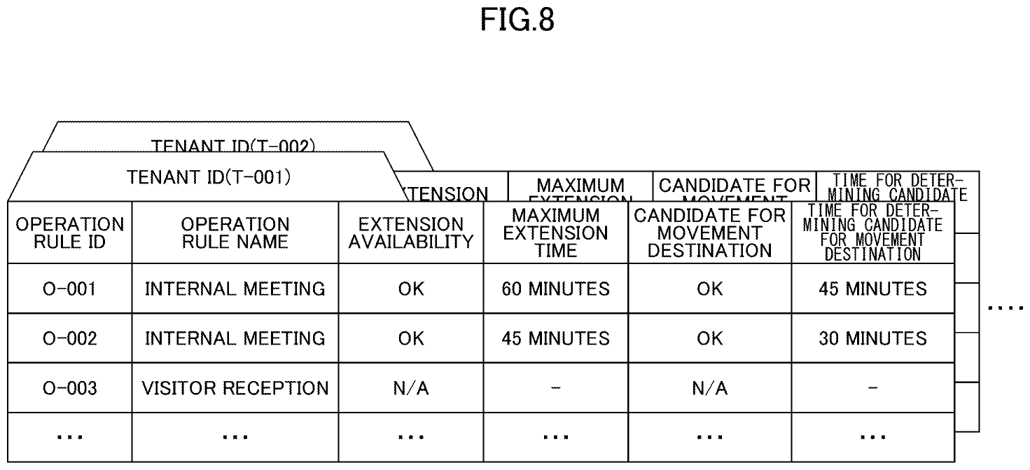

FIG. 8 is a conceptual diagram illustrating an example of an extension movement management table according to the present embodiment. An extension movement management DB 5004 including an extension movement management table as illustrated in FIG. 8 is configured in the storage unit 5000. In the extension movement management table, the tenant ID described above used as a tab, and an operation rule name, an extension availability, a maximum extension time, a candidate for movement destination, and a time for determining the candidate for movement destination are stored and managed in association with each operation rule ID divided by each tab.

The operation rule ID is identification information for identifying a purpose of use of the resource to be reserved.

The operation rule name is a name that rules an operation of the resource corresponding to the operation rule ID, and is given, for example, for an internal meeting, for visitor reception, and the like. Further, the operation rule manages the following information in the applied resources such as a meeting room.
Reservation extension availability
Extension time when extending the reservation
Availability of being specified as a candidate for movement destination when moving from the resource currently in use (being utilized) to another resource
Time for determining when specifying the candidate for the movement destination

The details of each of the above-mentioned information will be described appropriately.

The extension availability indicates whether or not the resource currently in use (being utilized) can be extended. The extension of the resource currently in use will be available by satisfying the following two conditions.
Resource currently in use is permitted to be extended (“OK” in the “Extension Availability” item)
Resource currently in use exists for more than a predetermined time (for example, 10 minutes) until the next reservation start date and time

Note that the above-mentioned “predetermined time” may be set by an administrator of the resource management server 5 in the operation rule. In that case, an item such as “time determined to be extendable” that can be appropriately set by the administrator may be added to the extension movement management table.

The maximum extension time represents, the maximum value of the extension time that can extend the reservation with a single extension operation, when the resource currently in use (being utilized) can be extended. The administrator can set the maximum extension time to any value. For example, for a resource where a meeting is being held, if the “maximum extension time” is set to “60 minutes” and the next reservation start date and time is set to one and a half hours (90 minutes) later in the extension movement management table, the administrator extends the current meeting by 60 minutes through an extension operation (can be extended by the “maximum extension time”). However, in the present embodiment, even if 90 minutes are left until the next reservation start date and time, the administrator operates so as not to extend beyond the “maximum extension time” through a single operation. In that case, the administrator can extend the extended resource for a total of 90 minutes by performing another 30-minute extension operation.

On the other hand, if the next reservation start date and time is 10 minutes later, the administrator can extend the current meeting by only 10 minutes through the extension operation. That is, as for the time to be extended, the next reservation start date and time has priority over the “maximum extension time”.

The candidate for movement destination is information for setting whether or not the movement destination is available for the corresponding operation rule ID. In the present embodiment, for example, the operation rule IDs O-001 and O-002 are set to be “OK” as the candidate for movement destination. On the other hand, when the operation rule ID is O-003, it is set as “not allowed (N/A)” as the candidate for movement destination.

When considering another resource as the candidate for movement destination from the resource currently in use, if there is more than a predetermined time from the current time to the latest reservation start date and time of another resource, the time for determining the candidate for movement destination is the time when another resource may be used as the candidate for movement destination. The administrator can set the time for determining the candidate for movement destination to any value. For example, when considering moving from the currently in use resource (Meeting Room A) to another resource (Meeting Room B) as a candidate for movement destination,
1. “The time for determining the candidate for movement destination” of Meeting Room B is set to 30 minutes.
3. The current time is 14:50, and the latest reservation start date and time for Meeting Room B is 15:15 (the difference is 25 minutes).
4. “25 minutes” is less than 30 minutes, which is “the time for determining the candidate for movement destination” set in 1.

Therefore, Meeting Room B is a target to be excluded from the candidate for movement destination. Further, if it is not desirable to be the candidate for movement destination, the administrator of the resource management server 5 can also set the item of “candidate for movement destination” to “N/A” in the extension movement management table.

In the present embodiment, the extension movement management table (extension movement management DB 5004) functions as an example of the extension movement management unit.

«Each Functional Configuration of Resource Management Server»

Next, each functional configuration of the resource management server 5 will be described in detail. The transmitter/receiver 51 of the resource management server 5 illustrated in FIG. 4 is mainly implemented by the processing of the CPU 501, and by the external device connection I/F 507 and the network I/F 509 illustrated in FIG. 3. The transmitter/receiver 51 of the resource management server 5 transmits/receives various data (or information) to/from the information processing terminal 3 and the reservation management server 9 via the communication network 100. In the present embodiment, the transmitter/receiver 51 has a function as an example of the transmitter and the receiver.

The acquisition unit 52 is mainly implemented by the processing of the CPU 501 illustrated in FIG. 3, and acquires various information transmitted by the information processing terminal 3 received by the transmitter/receiver 51.

The calculation unit (clock unit) 53 is mainly implemented by the processing of the CPU 501 illustrated in FIG. 3. The calculation unit (clock unit) 53 calculates time in the determination processing of extension availability of the reserved resource by using, for example, a clock using the built-in clock of the CPU 501 and setting values of various tables.

The determination unit 55 is mainly implemented by the processing of the CPU 501 illustrated in FIG. 3, and makes, for example, various determinations in the resource management server 5. Further, as described above, the determination unit 55 also determines the extension availability of the reserved resource and the movement availability to another resource. In the present embodiment, the determination unit 55 has a function as an example of the determination unit.

The resource management unit 56 is mainly implemented by the processing of the CPU 501 illustrated in FIG. 3, and performs, for example, an extension processing related to reservation of each resource managed by the resource management server 5, a movement processing related to the movement, an update processing of the reservation information, and the like.

The storage/reading processing unit 59 is mainly implemented by the processing of the CPU 501 illustrated in FIG. 3, and stores various data (or information) in the storage unit 5000, and reads various data (or information) from the storage unit 5000.

The resource management server 5 mainly performs the following processing by each function or each functional unit described above.
Accessing the reservation management server 9 at predetermined intervals and updating the reservation information related to the reservation of the resource managed by the resource management server 5.
Providing the reservation information to be requested for the reservation information related to the reservation of the resource requested from the information processing terminal 3 at predetermined intervals
Regarding the operation for the reservation information requested from the information processing terminal 3, changing the reservation information related to the reservation of the target resource managed by the reservation management server 9 to update the resource information related to the reservation of the resource managed by the resource e management server 5
Updating the setting information of the resource management server 5 when the setting information managed by the resource management server 5 is changed by the administrator who manages the resource management server 5

<Functional Configuration of Reservation Management Server>

As illustrated in FIG. 4, the reservation management server 9 includes a transmitter/receiver 91, a reservation information management unit 96, and a storage/reading processing unit 99. Each of these functional units is a function or a unit implemented by an operation, of any one of the configurations illustrated in FIG. 3, according to an instruction from the CPU 901 related to a program for the reservation management server 9 deployed on the RAM 903 from the ROM 902, the HDD 904, or both.

Further, the reservation management server 9 includes a storage unit 9000 configured by the ROM 902 or the HDD 904 illustrated in FIG. 3.

(Reservation Information Management Table)

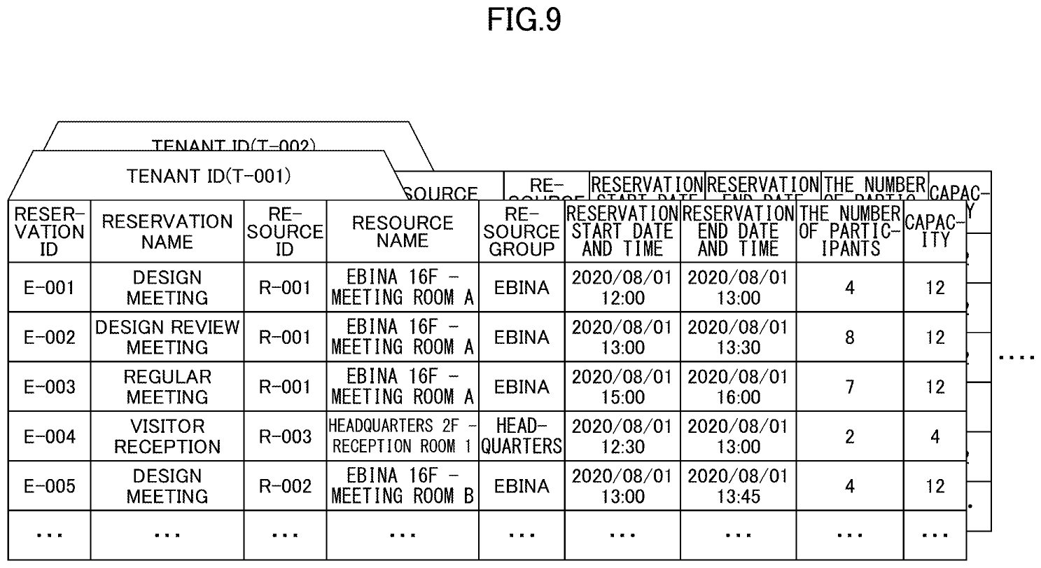

FIG. 9 is a conceptual diagram illustrating an example of the reservation management table according to the present embodiment. The reservation management DB 9001 including a reservation management table as illustrated in FIG. 9 is configured in the storage unit 9000. In the reservation management table, the tenant ID described above used as a tab, and a reservation name, a resource ID, a resource name, a resource group, reservation start date and time, reservation end date and time, the number of participants, and a capacity are stored and managed in association with each reservation ID divided by each tab. Since each of the above items has already been described in other data tables, a detailed description is omitted.

In the present embodiment, the reservation management table (reservation management DB 9001) functions as an example of the reservation management unit.

«Each Functional Configuration of Reservation Management Server»

Next, each functional configuration of the reservation management server 9 will be described in detail. The transmitter/receiver 91 of the reservation management server 9 illustrated in FIG. 4 is mainly implemented by the processing of the CPU 901, and by the external device connection I/F 907 and the network I/F 909 illustrated in FIG. 3. The transmitter/receiver 91 of the reservation management server 9 transmits/receives various data (or information) to/from the resource management server 5 via the communication network 100. Further, the transmitter/receiver 91 receives a login authentication request or a reservation setting when the resource of the information processing terminal 3 is used.

The reservation information management unit 96 is mainly implemented by the processing of the CPU 501 illustrated in FIG. 3, and manages the reservation information related to the reservation of the resource registered by the user and the schedule information indicating the user's schedule. The reservation information management unit 96 reads various reservation information from the reservation management DB 9001 described above and transmits the various reservation information to the resource management server 5 via the transmitter/receiver 91.

The storage/reading processing unit 99 is mainly implemented by the processing of the CPU 901 illustrated in FIG. 3, and stores various data (or information) in the storage unit 9000, and reads various data (or information) from the storage unit 9000.

The reservation management server 9 mainly performs the following processing by each function or each functional unit described above.
Providing the reservation information related to reservation of the target resource for the resource information requested from the resource management server 5 at predetermined intervals
Creating, changing, and deleting the reservation information related to the reservation of the target resource in response to requests from the resource management server 5

[Processing or Operation of Embodiment]

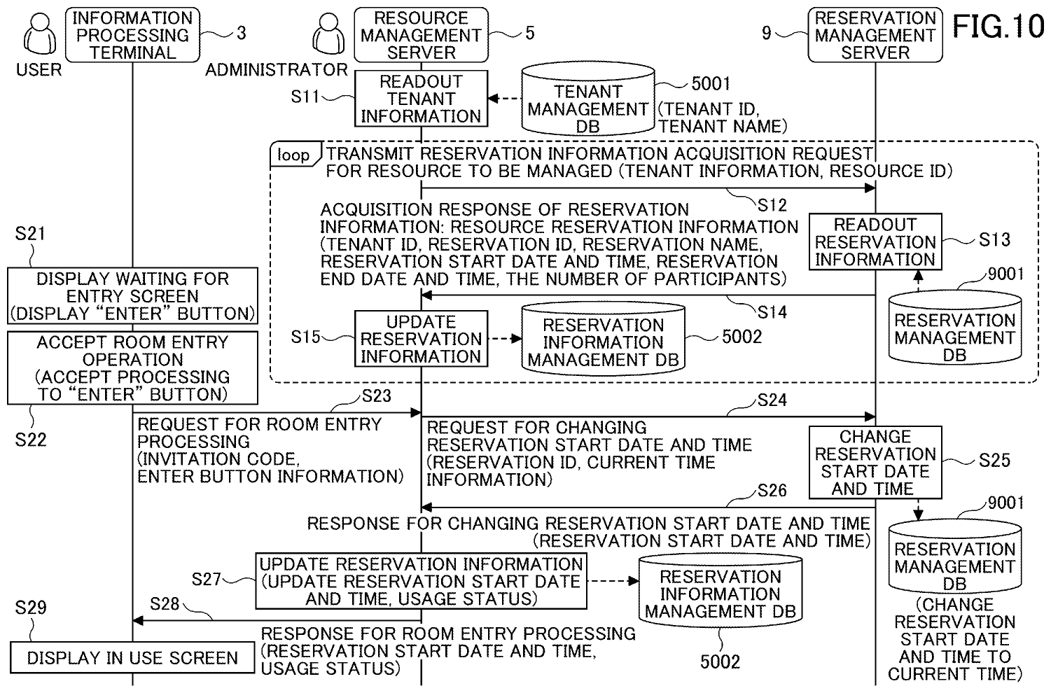

Next, each processing or operation in the communication system 1 according to the present embodiment will be described with reference to FIG. 10 to FIG. 17.

<Schedule Information Acquisition and Resource Usage Start Processing>

FIG. 10 is a sequence diagram illustrating an example of schedule information acquisition and resource usage start processing according to the present embodiment. As illustrated in FIG. 10, first, the storage/reading processing unit 59 of the resource management server 5 reads out the tenant ID and the corresponding tenant name as tenant information from the tenant table by the operation of the administrator to configure the tenant management DB 5001 (step S11). In the present embodiment, each resource used in the tenant name: Division A, corresponding to the tenant ID: T-001, will be described below.

Subsequently, the transmitter/receiver 51 transmits a reservation information acquisition request for the resource to be managed to the reservation management server 9 at a predetermined frequency or cycle (step S12). As a result, the transmitter/receiver 91 of the reservation management server 9 receives the reservation information acquisition request transmitted by the resource management server 5. When transmitting the reservation information acquisition request described above, the transmitter/receiver 51 transmits the acquisition request including the tenant information and the resource ID to the reservation management server 9. As described above, the tenant information includes the tenant ID and the tenant name.

Subsequently, the storage/reading processing unit 99 of the reservation management server 9 searches the reservation management table (the reservation management DB 9001, refer to FIG. 9) stored and managed in the reservation management server 9 using the received tenant ID and reservation ID as search keys to read out the reservation information (schedule information) related to the reservation of the corresponding resource (step S13). The reservation information (schedule information) read at this time includes, for example, the reservation name, the resource ID, the resource name, the resource group, the reservation start date and time, the reservation end date and time, the number of participants, and the capacity.

The reservation management server 9 that has read out the reservation information (schedule information) transmits an acquisition response of the reservation information from the transmitter/receiver 91 to the resource management server 5 (step S14). The acquisition response of the reservation information includes the tenant ID, the reservation ID, the reservation name, the reservation start date and time, the reservation end date and time, and the number of participants. As a result, the transmitter/receiver 51 of the resource management server 5 receives the acquisition response of the reservation information including the tenant ID, the reservation ID, the reservation start date and time, the reservation end date and time, and the number of participants transmitted by the reservation management server 9.

Subsequently, the resource management unit 56 updates the corresponding items in the reservation information management table based on the acquisition response of the reservation information including the reservation ID, the reservation start date and time, and the reservation end date and time received in step S14 (step S15). The resource management server 5 can acquire reservation information related to the reservation of each resource in a predetermined period by repeating the processes from step S12 to step S15 with the reservation management server 9 (loop process). The frequency of repetition is preferably relatively high, for example, every few minutes, every 30 minutes, or every hour. Further, regarding the reservation information, the newly registered or changed reservation information may be automatically transmitted from the reservation management server 9 (push notification to the resource management server 5).

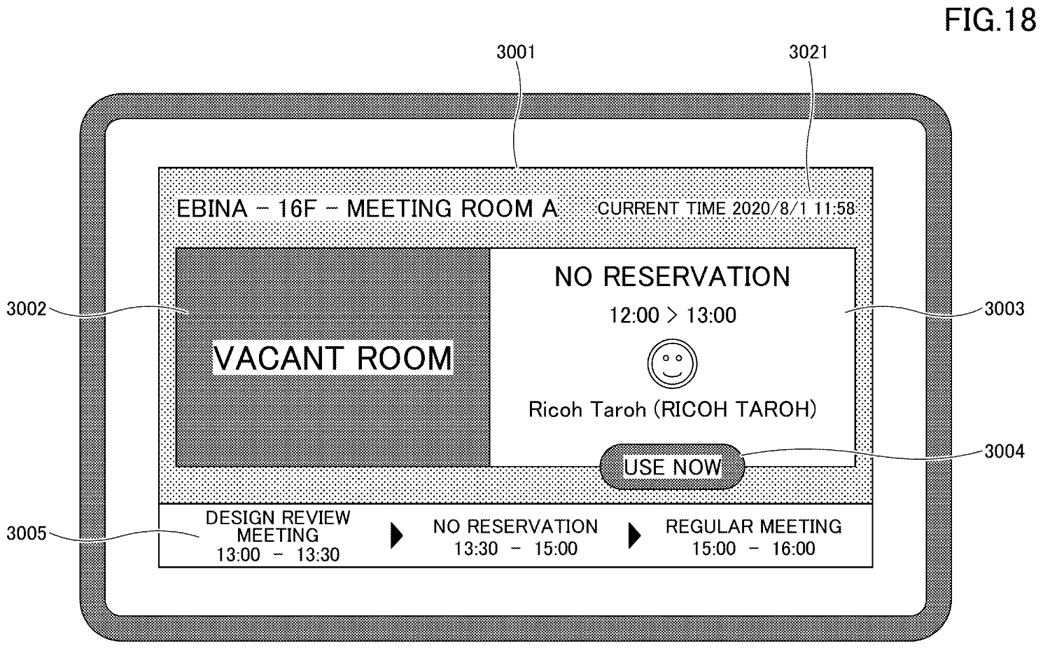

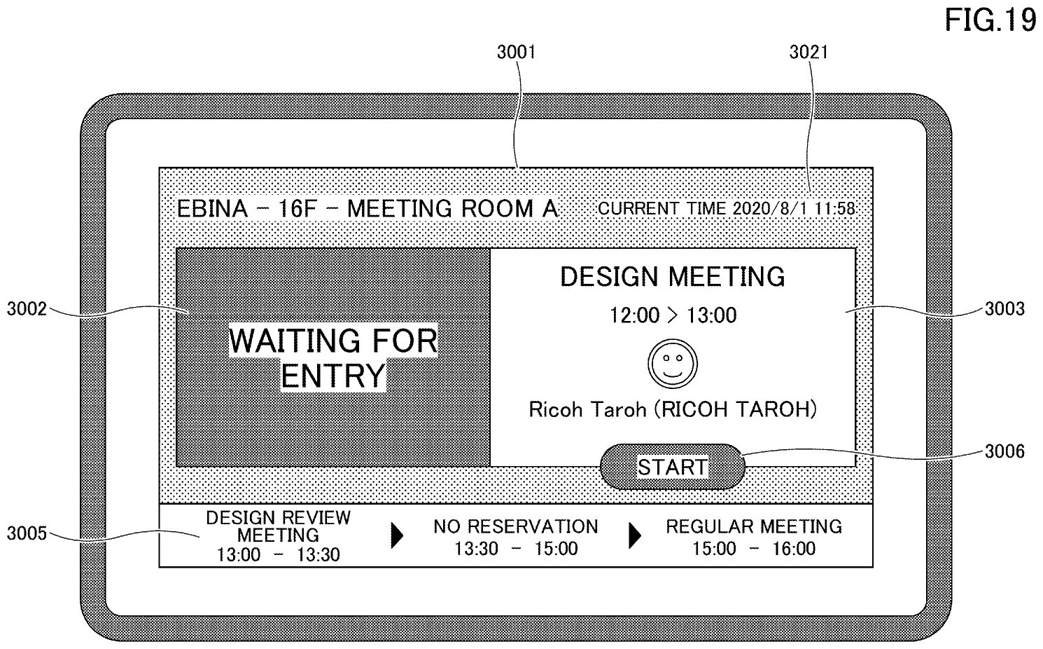

On the other hand, when the resource in which the information processing terminal is installed or arranged is unused, the display controller 34 of the information processing terminal 3 generates a screen based on data of a vacant room screen or data of a waiting for entry screen of the resource stored and managed in the storage unit 3000 read by the storage/reading processing unit 39. Then, the display controller 34 displays the generated screen on the display 318 (step S21). An example of the displayed screen is illustrated in FIG. 18 and FIG. 19. The details of the example of displayed screen will be described later.

Subsequently, the reception acquisition unit 32 accepts a room entry operation by the person who reserved the resource or the user of the resource (step S22). In the present embodiment, the premise is that the user of the resource reserves the resource associated with the information processing terminal 3 with the reservation management server 9 in advance. At this time, the user inputs the invitation code, transmitted from the resource management server 5 for the resource to be used, into the predetermined input location provided on the display 318 of the information processing terminal 3 to perform processing such as pressing a “START” button. At this time, the reception acquisition unit 32 may cooperate with the terminal authentication unit 33 to authenticate the user. The “START” button may be displayed on the display 318 as an “ENTER” button.

After accepting the room entry operation from the user, the transmitter/receiver 31 transmits a request for room entry processing to the resource management server 5 (step S23). As a result, the transmitter/receiver 51 of the resource management server 5 receives the request for room entry processing from the information processing terminal 3. At this time, the request for room entry processing includes the invitation code and each set of information related to the enter button inputted by the user.

The transmitter/receiver 51 of the resource management server 5 that has received the request for room entry processing transmits a request for changing the reservation start date and time to the reservation management server 9 (step S24). As a result, the transmitter/receiver 91 of the reservation management server 9 receives the request for changing the reservation start date and time transmitted by the resource management server 5. The request for changing the reservation start date and time includes the reservation ID and each set of information related to the current time.

The storage/reading processing unit 99 of the reservation management server 9 that has received the request for changing the reservation start date and time changes the reservation start date and time of the resource to be reserved, managed in the reservation management table, to the current time (step S25).

The transmitter/receiver 91 of the reservation management server 9 that has changed the reservation start date and time of the resource to be reserved in step S25 transmits a response for changing the reservation start date and time to the resource management server 5 (step S26). As a result, the transmitter/receiver 51 of the resource management server 5 receives the response for changing the reservation start date and time transmitted by the reservation management server 9. At this time, the response for changing the reservation start date and time includes each set of information related to the reservation start date and time changed to the current time for the resource to be reserved.

The storage/reading processing unit 59 of the resource management server 5 that has received the response for changing the reservation start date and time updates the reservation start date and time of the resource to be reserved, managed in the reservation in formation management table, to the information of the received reservation start date and time. Further, the storage/reading processing unit 59 updates the usage status of the resource to be reserved from “waiting for entry” to “in use” (step S27).

Subsequently, the transmitter/receiver 51 transmits a response for the room entry processing for the resource to be reserved to the information processing terminal 3 (step S28). As a result, the transmitter/receiver 31 of the information processing terminal 3 receives the response for the room entry processing transmitted from the resource management server 5. At this time, the response for the room entry processing includes information on the latest reservation start date and time of the resource to be reserved and usage status information indicating the usage status of the resource. That is, the latest reservation start date and time information indicating the latest reservation start date and time of the resource to be reserved and the usage status information indicating the resource usage status is an example of predetermined reservation information updated for a reservation of a predetermined resource.

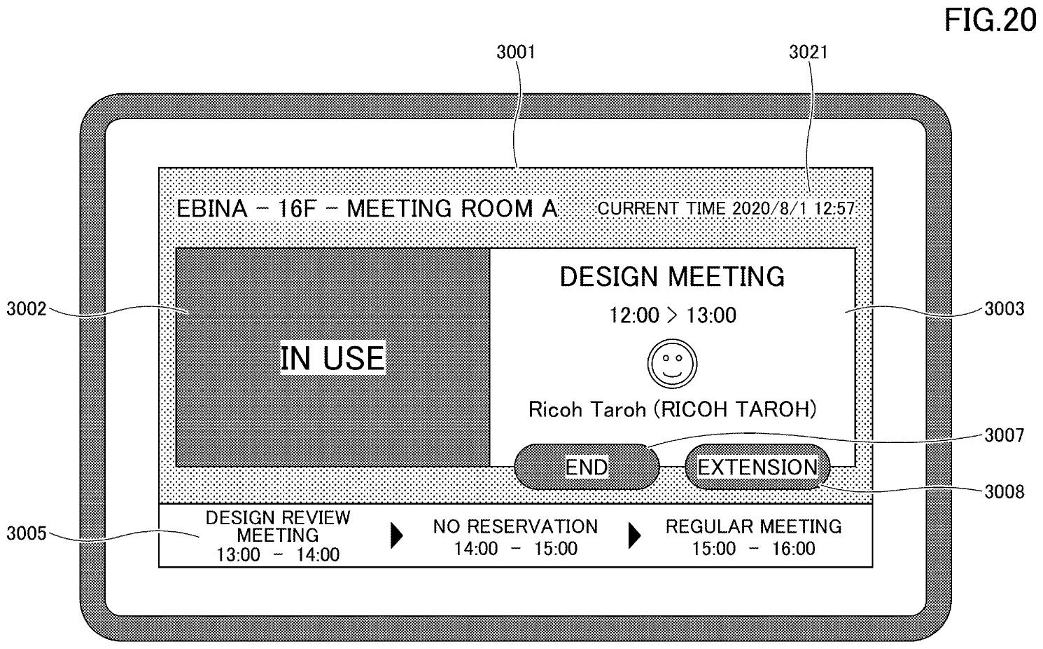

The display controller 34 of the information processing terminal 3 displays, for example, the “in use” screen on the resource on the display 318, as illustrated in FIG. 20, based on the received response for the room entry processing and the screen data displayed in the room entry processing in step S21. The screen data related to the “in use” screen of this resource is read out from the storage unit 3000 by the storage/reading processing unit 39 after the processing in step S28.

In the communication system 1 (resource management system 7) according to the present embodiment, when the processes of steps S23 and S28 described above are executed, another device may exist between the information processing terminal 3 (information processing terminal) and the resource management server 5 (resource management apparatus). That is, each information transmitted/received between the information processing terminal 3 and the resource management server 5 may be configured to be transmitted/received once via another device. The previously described configuration and the processing method may also be applied to other processing steps executed between the information processing terminal 3 (information processing terminal) and the resource management server 5 (resource management apparatus).

Further, in the communication system 1 (resource management system 7) according to the present embodiment, when the processes of steps S12 and S14 described above are executed, another device may exist between the resource management server 5 (resource management apparatus) and the reservation management server 9 (reservation management device). That is, each information transmitted/received between the resource management server 5 and the reservation management server 9 may be configured to be transmitted/received once via another device. The previously described configuration and the processing method may also be applied to other processing steps executed between the resource management server 5 (resource management apparatus) and the reservation management server 9 (reservation management device).

<Periodic Update Processing of Reservation Information>

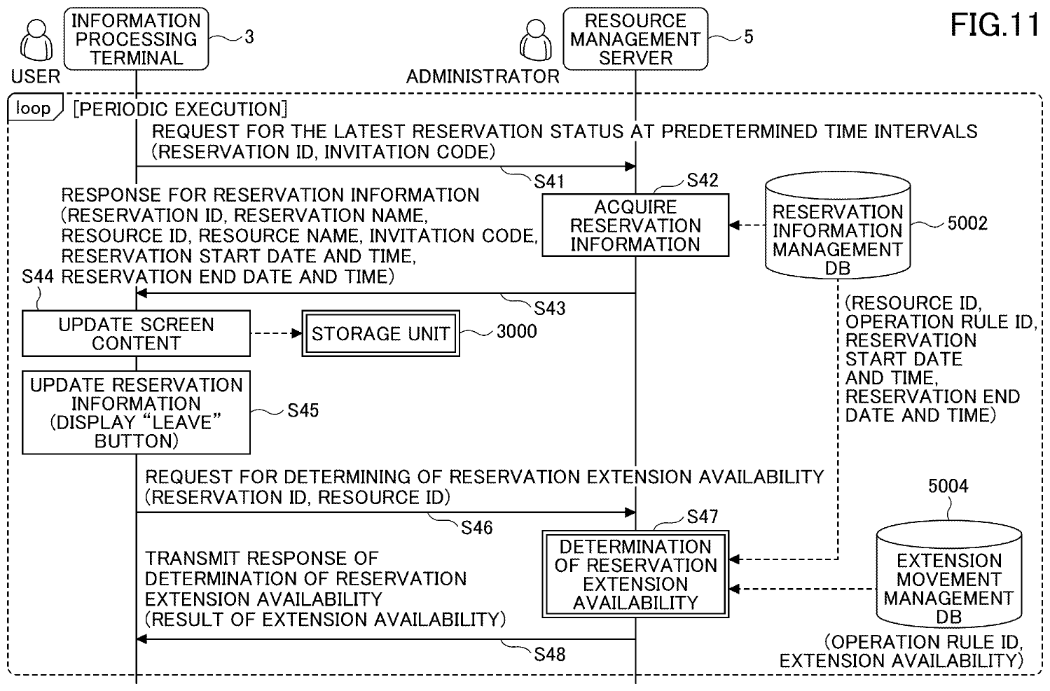

FIG. 11 is a sequence diagram illustrating an example of periodic update processing of reservation information according to the present embodiment. As illustrated in FIG. 11, first, the transmitter/receiver 31 of the information processing terminal 3 transmits a request for the latest reservation status to the resource management server 5 at predetermined time intervals (step S41). As a result, the transmitter/receiver 51 of the resource management server 5 receives the request for the reservation information transmitted by the information processing terminal 3. At this time, the request for reservation information includes, for example, the reservation ID and the invitation code associated with the person who reserved the resource. In the present embodiment, the case where “0396” is used as the invitation code will be described.

The storage/reading processing unit 59 of the resource management server 5 that has received the request for reservation information searches the reservation information management table (the reservation information management DB 5002, refer to FIG. 6) using the invitation code (0396) as a search key to read out corresponding reservation information (step S42). The reservation information read out includes each set of information related to the reservation ID (E-001) corresponding to the invitation code (0396), the resource ID (R-001), and the usage status (in use). The “Ebina 16F—Meeting Room A” indicated by the resource ID (R-001) is an example of a predetermined resource.

The transmitter/receiver 51 of the resource management server 5 that has received the reservation information related to the reserved resource transmits a response for the reservation information to the information processing terminal 3 (step S43). As a result, the transmitter/receiver 31 of the information processing terminal 3 receives the response for the reservation information transmitted from the resource management server 5. At this time, the response for the reservation information includes information related to the reservation ID (E-001), the reservation name (design meeting), the resource ID (R-001), the resource name (Ebina 16F—Meeting Room A), the invitation code (0396), the reservation start date and time (2020/08/01 12:00), the reservation end date and time (2020/08/01 13:00), and the usage status (in use).

Subsequently, the display controller 34 of the information processing terminal 3 updates a screen content to be displayed on the display 318 based on a content of the reservation information related to the reservation of the received resource (step S44). At this time, the storage/reading processing unit 39 newly stores the updated screen content data in the storage unit 3000.

Next, the display controller 34 displays a screen according to the received usage status on the display 318 as an update processing of the reservation information related to the resource reservation (step S45). Specifically, if the usage status included in the received response for the reservation information is “in use”, the display controller 34 displays on the display 318 an “END” button that allows the user to select to finish the use of the target resource. The “END” button may be displayed on the display 318 as a “LEAVE” button.

Subsequently, the transmitter/receiver 31 transmits a request for determining of reservation extension availability of the reserved resource to the resource management server 5 (step S46). As a result, the transmitter/receiver 51 of the resource management server 5 receives the request for determining of reservation extension availability of the reserved resource transmitted from the information processing terminal 3. At this time, the request for determining of reservation extension availability includes the reservation ID (E-001) related to the reserved resource and the information related to the resource ID (R-001).

Upon receiving the request for determining of reservation extension availability, the determination unit 55 of the resource management server 5 executes a determination of reservation extension availability as to whether or not the reserved resource can be extended and can be used (step S47).

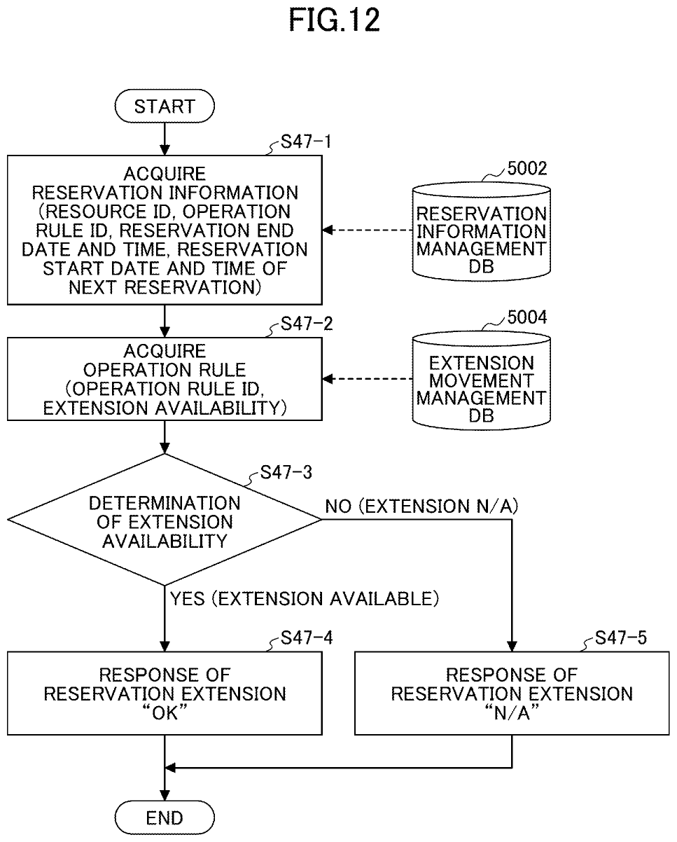

The determination of reservation extension availability will be described in detail with reference to the flowchart of FIG. 12.

After the determination of extension availability is executed in step S47, the transmitter/receiver 51 transmits a response as a result of the determination of reservation extension availability to the information processing terminal 3 (step S48). As a result, the transmitter/receiver 31 of the information processing terminal 3 receives the response as a result of the determination of reservation extension availability transmitted from the resource management server 5.

<Determination Processing of Resource Extension Availability>

FIG. 12 is a flowchart illustrating an example of a determination of resource extension availability according to the present embodiment. First, the acquisition unit 52 acquires each information managed by the reservation information management table and read out from the storage/reading processing unit 59 (step S47-1), such as the resource ID (R-001), the operation rule ID (O-001), the reservation end date and time of the resource currently in use (2020/08/01 13:00), the reservation start date and time of the next reservation that is most recent to the resource currently in use (2020/08/01 13:00). In this regard, the information on the usage start date and time is acquired because other reservations other than the reservation currently being reserved may be reserved for the acquired resource ID (R-001).

Subsequently, the acquisition unit 52 acquires the operation rule ID and the information on the extension availability, which is managed by the extension movement management table and read out from the storage/reading processing unit 59 (step S47-2).

Next, the determination unit 55 determines the extension availability of the resource currently in use, by comparing each reservation information (such as the resource ID (R-001), the operation rule ID (O-001), the reservation start date and time (2020/08/01 13:00), and an extension availability (“OK”) corresponding to the operation rule ID (O-001)), acquired by the acquisition unit 52 in steps S47-1 and S47-2, with the reservation end date and time of the resource currently in use (2020/08/01 13:00) (step S47-3).

If the reservation of the resource currently in use is determined to be “OK” (step S47-3; YES) by the determination of the extension availability of the determination unit 55, the transmitter/receiver 51 transmits a response of the reservation extension “OK” to the information processing terminal 3 to exit this flow in step S48 (step S47-4).

On the other hand, if the reservation of the resource currently in use is determined to be “N/A” (step S47-3; NO) by the determination of the extension availability of the determination unit 55, the transmitter/receiver 51 transmits a response of the reservation extension “N/A” to the information processing terminal 3 to exit this flow in step S48 (step S47-5). In the above example, since the reservation end date and time of the resource currently in use and the reservation start date and time of the next reservation are the same date and time (2020/08/01 13:00), the reservation extension is “N/A”.

<Display Processing of Extension Button and Move Button>

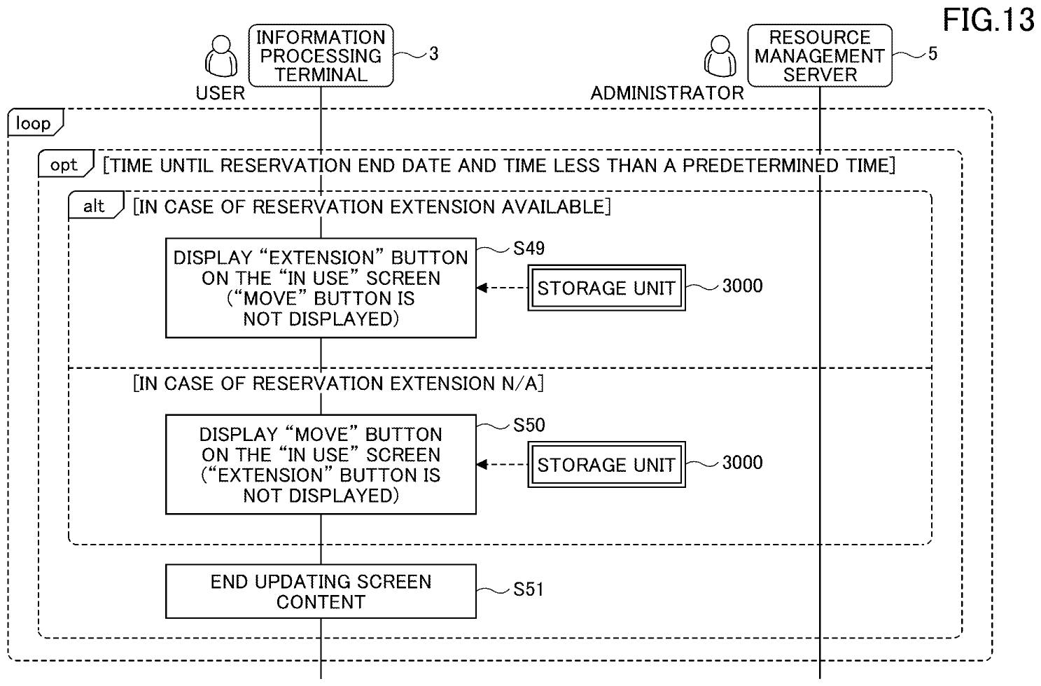

FIG. 13 is a sequence diagram illustrating an example of extension and movement of the resource according to the present embodiment. The display controller 34 of the information processing terminal 3 that has received the response of the reservation extension “OK” from the resource management server 5 displays an “END” button and an “EXTENSION” button on the display 318 as in the screen example illustrated in FIG. 20 (step S49), and ends the update of the screen content (step S51). That is, in this case, the “MOVE” button is not displayed.

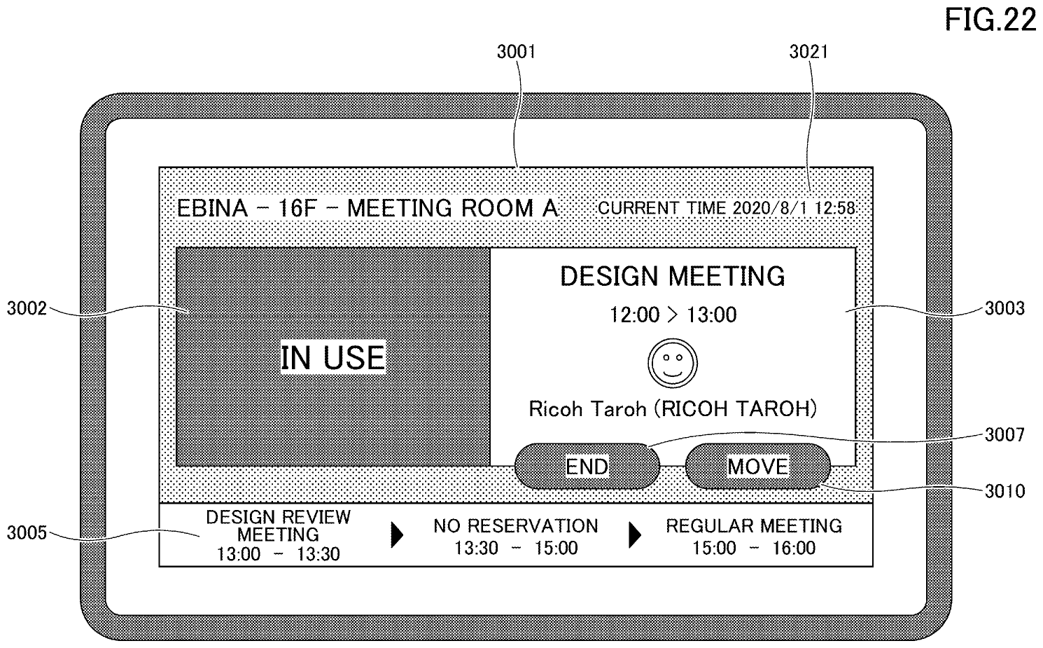

On the other hand, the display controller 34 of the information processing terminal 3 that has received the response of the reservation extension “N/A” from the resource management server 5 displays an “END” button and a “MOVE” button on the display 318 in the “in use” screen as in the screen example illustrated in FIG. 22 (step S50), and ends the update of the screen content (step S51). That is, in this case, the “EXTENSION” button is not displayed.

As described above, the transmitter/receiver 51 transmits, based on the reservation status after the reservation end date and time obtained from a result of comparing the received reservation information with the reservation end date and time information indicating the reservation end date and time of a predetermined resource currently in use (Ebina 16F—Meeting Room A, hereinafter simply referred to as Meeting Room A), an extension selection information for prompting a selection of whether to extend the use of the meeting room A (an operation of the “EXTENSION” button illustrated in FIG. 20) if the meeting room A is available for continued reservation to the information processing terminal 3. On the other hand, if the meeting room A is not available for continued reservation, movement selection information for prompting a selection of whether to move from the meeting room A to another resource, for example, another meeting room such as the meeting room B, (operation to the “Move” button illustrated in FIG. 22) is transmitted to the information processing terminal 3. At this time, the transmitter/receiver 51 transmits the extension selection information or the movement selection information to the information processing terminal 3 after a predetermined time from the reservation start date and time of the resource currently in use. More specifically, the predetermined time may be set to any time between the reservation start date and time and the reservation end date and time of the resource currently in use.

Further, the information processing terminal 3 can display the “END” button and the “EXTENSION” button when the time until the reservation end date and time of the resource currently in use becomes less than a predetermined time. That is, if the time until the reservation end date and time of the resource currently in use is equal to or longer than the predetermined time, the display controller 34 displays only the reservation information and the “END” button on the display 318. On the other hand, if the time until the reservation end date and time of the resource currently in use is less than the predetermined time, the display controller 34 displays the “EXTENSION” or the “END” button on the display 318 depending on whether the reservation of the resource currently in use can be extended or not.

The previously described processes from step S41 to step S51 are periodically repeated between the information processing terminal 3 and the resource management server 5 (loop process).

<Selection Processing of Candidate Resource for Movement Destination>

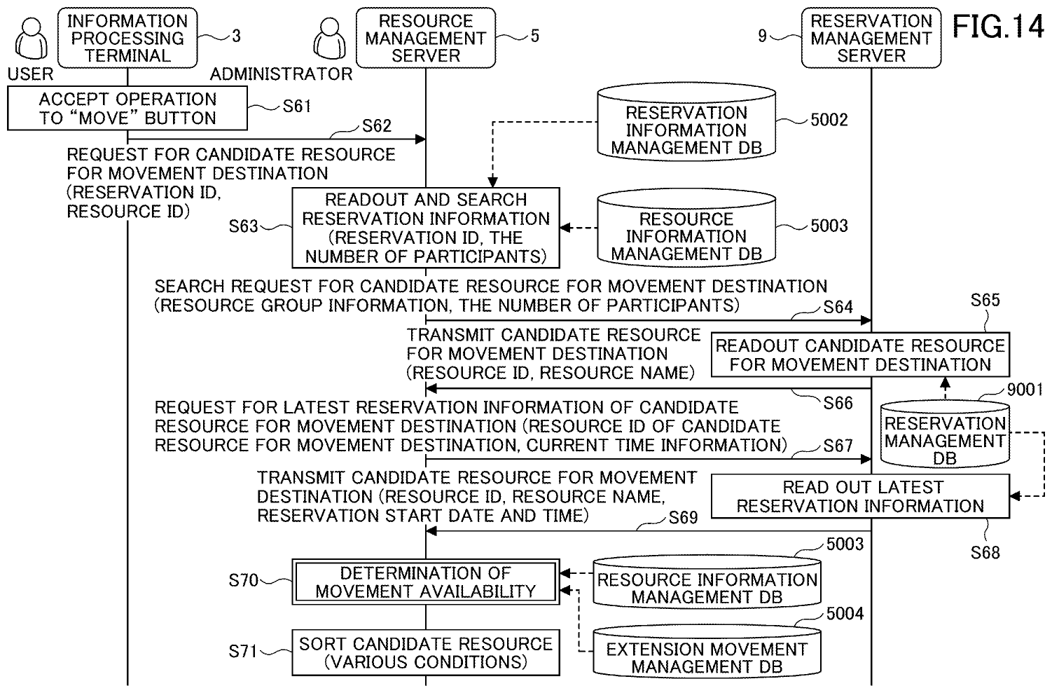

Next, the case of moving from the resource currently in use to another resource will be described. FIG. 14 is a sequence diagram illustrating an example of selection processing of a candidate resource for a movement destination according to the present embodiment. First, the reception acquisition unit 32 of the information processing terminal 3 receives an operation on the “MOVE” button by the user (step S61).

After the operation to the “MOVE” button is received by the reception acquisition unit 32, the transmitter/receiver 31 transmits a request for the candidate resource for the movement destination to the resource management server 5 (step S62). As a result, the transmitter/receiver 51 of the resource management server 5 receives the request for the candidate resource for the movement destination transmitted from the information processing terminal 3. At this time, the request for the candidate resource for the movement destination includes each set of information related to the reservation ID and the resource ID of the resource currently in use.

Subsequently, the storage/reading processing unit 59 searches the reservation information management table (the reservation information management DB 5002, refer to FIG. 6) using the received reservation ID as a search key to read out the corresponding resource ID, operation rule ID, and the number of participants. Further, the storage/reading processing unit 59 searches the resource information management table (the resource information management DB 5003, refer to FIG. 7) using the resource ID as a search key to read out the corresponding capacity (step S63).

Subsequently, the transmitter/receiver 51 transmits a search request for the candidate resource for the movement destination to the reservation management server 9 (step S64). As a result, the transmitter/receiver 91 of the reservation management server 9 receives the search request for the candidate resource for the movement destination transmitted from the resource management server 5. At this time, the search request for the candidate resource for the movement destination includes each information related to the resource ID, the number of participants, and the capacity.

In this regard, when the resource management server 5 transmits the search request for the candidate resource of the movement destination to the reservation management server 9, the conditions required as the candidate resource for the movement destination are, for example, as below.
The resource belongs to the same resource group as the resource currently in use by the user
The resource has a capacity of equal to or more than the number of participants registered in the reserved event in which the user is currently participating

However, the conditions required as the candidate resource for the movement destination are not limited to described above.

Subsequently, the storage/reading processing unit 99 searches the reservation management table (the reservation management DB 9001, refer to FIG. 9) using the resource ID as a search key to read out the corresponding resource group and capacity (step S65).

Subsequently, the transmitter/receiver 91 transmits to the resource management server 5 resource information (the resource ID, the resource name, the resource group, the capacity) of 0 or more resources to be candidates for the movement destination as a response for the candidate resource for the movement destination (step S66). At this time, the candidate resource for the movement destination belongs to the same resource group as the resource currently in use, and has a capacity larger than the number of participants in the reservation being used. As a result, the transmitter/receiver 51 of the resource management server 5 receives the resource information (the resource ID, the resource name, the resource group, the capacity), transmitted from the reservation management server 9, of 0 or more resources to be candidates for the movement destination.

Further, the transmitter/receiver 51 transmits a request for latest reservation information of the candidate resource for the movement destination to the reservation management server 9 (step S67). As a result, the transmitter/receiver 91 of the reservation management server 9 receives the request for latest reservation information of the candidate resource for the movement destination transmitted from the resource management server 5. At this time, the request for latest reservation information of the candidate resource for the movement destination includes the resource ID of the candidate resource for the movement destination and the current time information representing the current time.

The reservation information management unit 96 and the storage/reading processing unit 99 of the reservation management server 9 that have received the request for latest reservation information of the candidate resource for the movement destination search the reservation management table (the reservation management DB 9001, refer to FIG. 9) using the received current time information as a search key to read out corresponding latest reservation information of the candidate resource for the movement destination (step S68). Specifically, the reservation information management unit 96 and the storage/reading processing unit 99 read out the reservation information of “Ebina 16F—Meeting room B” indicated by the resource ID (R-002).

Subsequently, the transmitter/receiver 91 transmits the read out latest reservation information (reservation information of “Ebina 16F—Meeting room B”) of the candidate resource for the movement destination to the resource management server 5 (step S69). As a result, the transmitter/receiver 51 of the resource management server 5 receives the latest reservation information (reservation information of “Ebina 16F—Meeting room B”) of the candidate resource for the movement destination transmitted from the reservation management server 9.

The calculation unit (clock unit) 53 and the determination unit 55 of the resource management server 5 that have received the latest reservation information of the candidate resource for the movement destination determine the movement availability (step S70). Specifically, the calculation unit (clock unit) 53 and the determination unit 55 calculate time from the current time to the latest reservation start date and time of each resource candidate. If the time is less than the determination time set for each candidate resource for the movement destination, that resource is excluded from the candidate resource for the movement destination. The detailed processing of step S70 will be described in the flowchart for determination of selection availability of the candidate resource for the movement destination, which will be described later.

After determining the selection availability of the candidate resource for the movement destination, the resource management unit 56 performs an arranging processing (sorting) of the candidate resource for the movement destination using various predetermined conditions (step S71). The various predetermined conditions described above include, for example, an order in which a distance to the resource currently in use is close, an order in which an extension time is long, an order in which a capacity is large, and the like. Further, the various predetermined conditions can be preset by the administrator of the resource management server 5.

<Determination Processing of Selection Availability of Candidate Resource for Movement Destination>

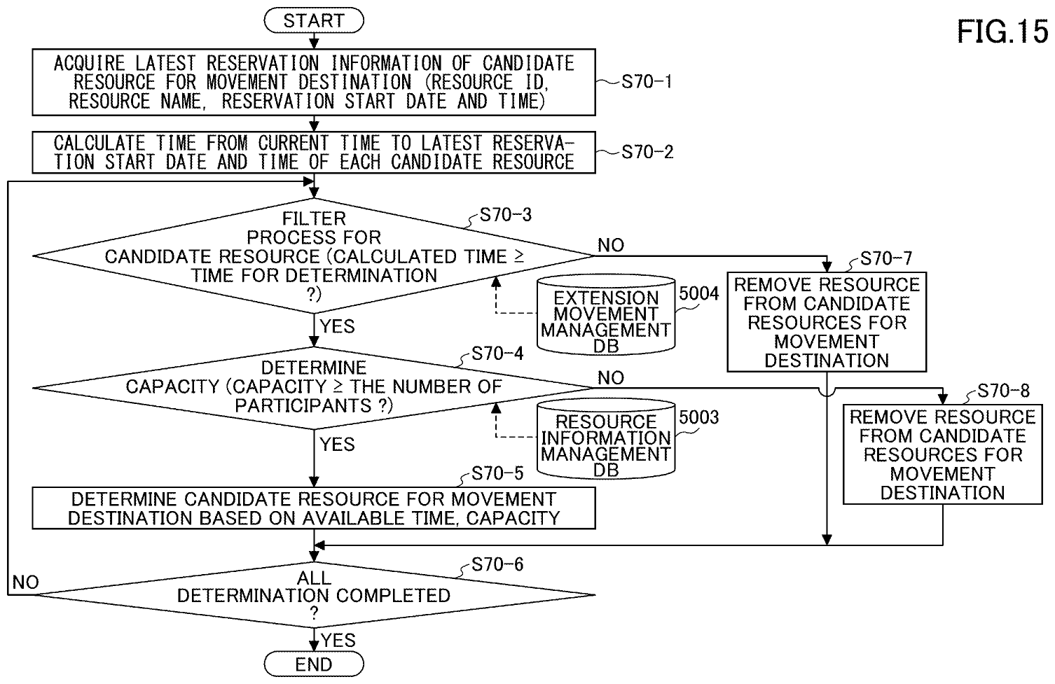

FIG. 15 is a flowchart illustrating an example of a determination processing of selection availability of candidate resource for the movement destination according to the present embodiment. First, as described in step S69, the acquisition unit 52 of the resource management server 5 acquires, as the latest reservation information of the candidate resource for the movement destination transmitted from the reservation management server 9, the resource ID (R-002), the resource name (“Ebina 16F—Meeting room B”), and the reservation start date and time (step S70-1).

Subsequently, the calculation unit (clock unit) 53 calculates the time from the current time to the latest reservation start date and time of each candidate resource for the movement destination (step S70-2).

After that, the determination unit 55 searches the extension movement management table (the extension movement management DB 5004, refer to FIG. 8) using the time calculated in step S70-2 and the determination time prepared in advance to perform a candidate resource extraction process (filter process) (step S70-3). Specifically, the determination unit 55 performs a candidate resource extraction process (filter process) by determining whether the calculated time is longer than the “determination time for the candidate for the movement destination” being managed in the extension movement management table. The “determination time for the candidate for the movement destination” is a time having the same meaning as the determination time prepared in advance. The determination unit 55 may, in the process of step S70-3, search the extension movement management table (the extension movement management DB 5004, refer to FIG. 8) to add processing for determining availability (OK, N/A) of “candidate for the movement destination” of the resource.

If the time calculated in step S70-2 is equal to or longer than the determination time for the candidate for the movement destination (step S70-3; YES), the determination unit 55 searches the resource information management table (the resource information management DB 5003, refer to FIG. 7) using the number of participants participating in a predetermined event being held in the currently reserved resource as a search key to determine the capacity of the candidate resource for the movement destination (step S70-4). In this way, when the resource currently being used is not available for continued reservation, the determination unit 55 determines whether the resource can be moved from that resource to another resource by executing each of the processes of step S70-3 and step S70-4 described above.

If the capacity of the candidate resource for the movement destination is equal to or greater than the number of participants (step S70-4; YES), the determination unit 55 and the resource management unit 56 determine the candidate resource for the movement destination based on conditions such as available time and capacity (step S70-5).

The determination unit 55 determines whether the process for all the candidate resources for the movement destination has been completed (step S70-6). Then, if the determination is completed (step S70-6; YES), this flow is exited and the process of step S71 is executed.

On the other hand, if the determination is not completed (step S70-6; NO), the process returns to the process of step S70-3, and the process of the next candidate resources for the movement destination is executed. That is, the determination unit 55 and the resource management unit 56 repeat the processes of step S70-3 to step S70-6 until processing has been performed equal to the number of candidate resources for the movement destination.

If the time calculated in step S70-2 is less than the determination time for the candidate for the movement destination (step S70-3; NO), the determination unit 55 and the resource management unit 56 remove that resource from the candidate resources for the movement destination and transitions to the determination process of step S70-6 (step S70-7).

Further, if the capacity of the candidate resource for the movement destination is less than the number of participants (step S70-4; NO), the determination unit 55 and the resource management unit 56 remove that resource from the candidate resources for the movement destination and transitions to the determination process of step S70-6 (step S70-8).

Note that the above-described flowchart is an example of processing related to the determination of selection availability of the candidate resource for movement destination and is not limited to this.

<Display Processing of Candidate Resource for Movement Destination>

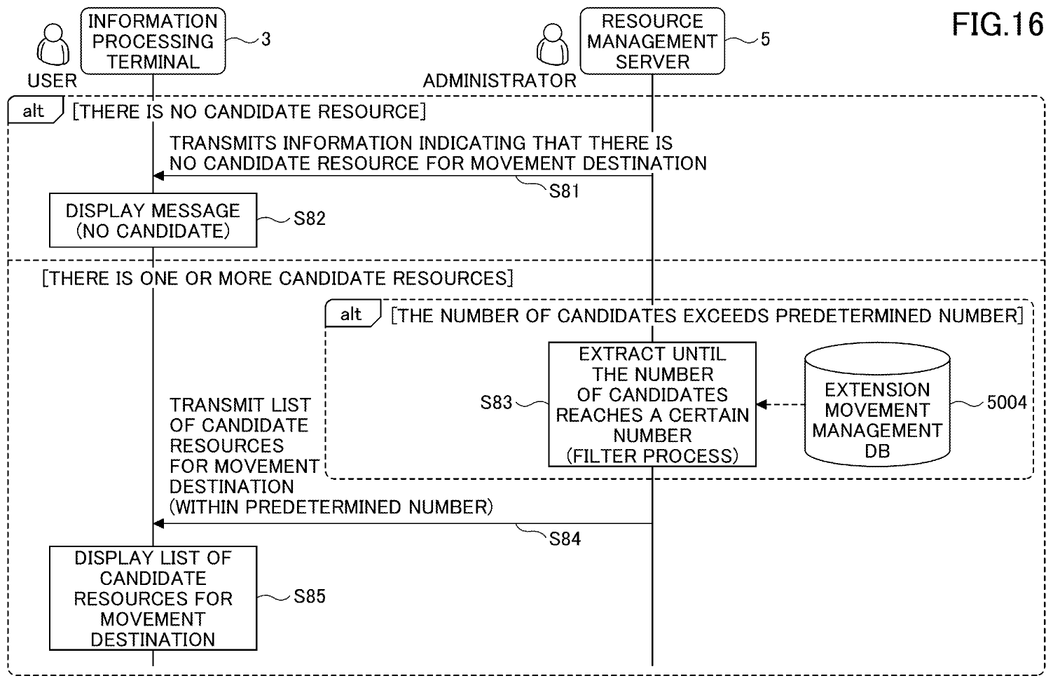

Next, the display processing of the candidate resource for movement destination will be described. FIG. 16 is a sequence diagram illustrating an example of display processing of the candidate resource for the movement destination according to the present embodiment. As described in step S70, if there is no candidate resource for the movement destination as a result of determining the movement availability, the transmitter/receiver 51 transmits information indicating that there is no candidate resource for the movement destination to the information processing terminal 3 (step S81). As a result, the transmitter/receiver 31 of the information processing terminal 3 receives the information indicating that there is no candidate resource for the movement destination transmitted from the resource management server 5.

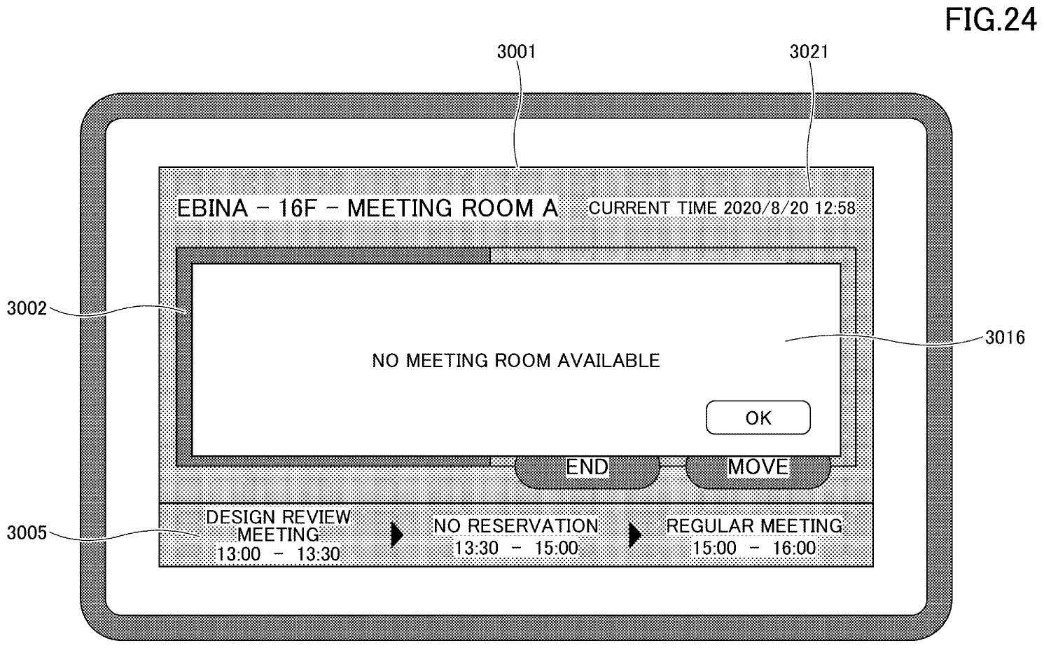

When the transmitter/receiver 31 receives the information indicating that there is no candidate resource for the movement destination, the display controller 34 displays a message indicating that there is no candidate resource for the movement destination on the display 318 (step S82). For example, a screen display example at this time may be a screen as illustrated in FIG. 24, which will be described later.

On the other hand, if it is determined that there is one or more candidate resource for the movement destination and also the number of candidates exceeds a predetermined number, the resource management unit 56 uses the extension movement management table (the extension movement management DB 5004, refer FIG. 8) to perform extraction processing (filter processing) until the number of candidates reaches a certain number (step S83). In the extraction processing (filter processing) performed at this time, for example, a resource in which the difference between the determination time for the candidate for the movement destination and the time calculated in step S70-2 is equal to or longer than a predetermined time may be excluded. That is, the resource with short time calculated in step S70-2 may be preferentially excluded.

Further, if it is determined that there is one or more candidate resource for the movement destination and also the number of candidates is within a predetermined number, the transmitter/receiver 51 transmits a list of candidate resources for the movement destination (resource list) to the information processing terminal 3 (step S84). As a result, the transmitter/receiver 31 of the information processing terminal 3 receives the list of candidate resources for the movement destination (resource list) transmitted from the resource management server 5.

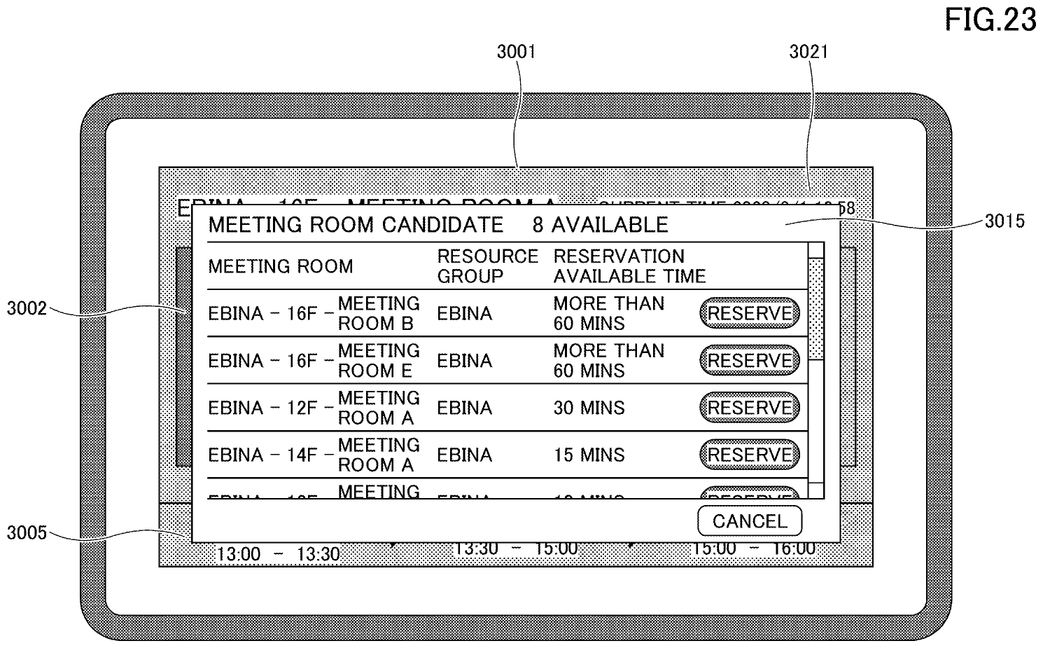

When the transmitter/receiver 31 receives information indicating that a predetermined number of candidate resources for the movement destination exists, the display controller 34 displays a list screen of the candidate resources for the movement destination on the display 318 (step S85). For example, a screen display example at this time may be a screen as illustrated in FIG. 23, which will be described later. For example, an order in which the location is close to the current resource, an order in which an extension time is long from the reservation end date and time (that is, an order in which an available time is long at the movement destination), an order of resources with an equipment similar to an equipment equipped in the resource currently in use, an order in which the capacity is large, and the like may be provided as a basis for determining an order of display of the candidate resources for the movement destination.

<Reservation Update Processing of Movement Destination Resource>

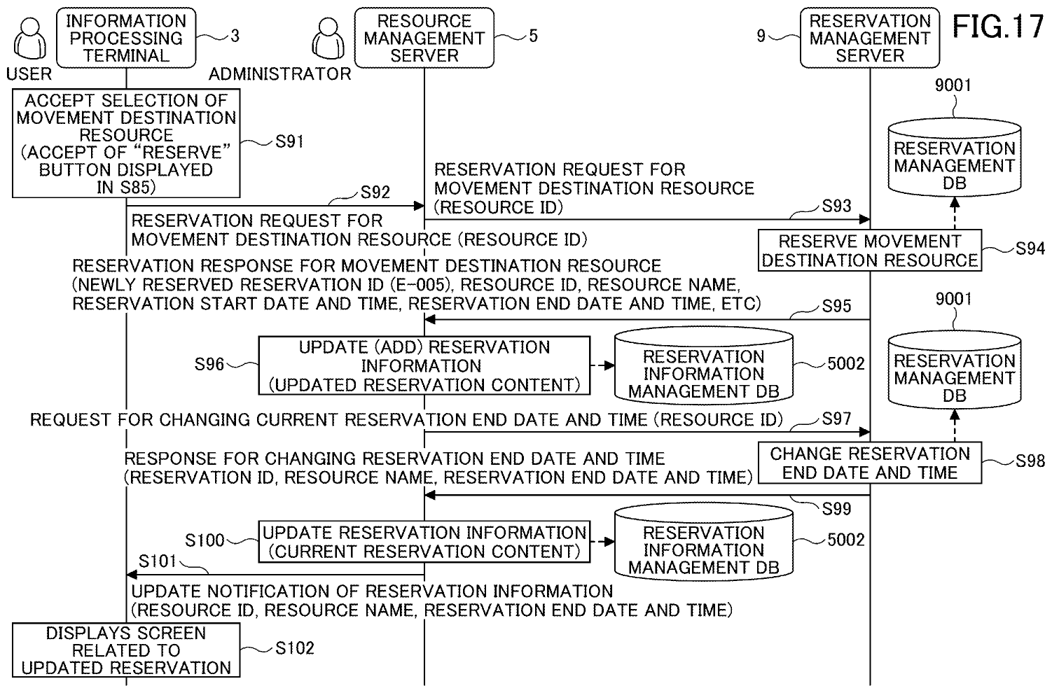

Next, the reservation update processing of movement destination resource will be described. FIG. 17 is a sequence diagram illustrating an example of a reservation update processing of movement destination resource according to the present embodiment. First, the user of the reserved resource operates the “RESERVE” button of the resource desired to be used from the movement destination resource displayed on the display 318 in the process of step S85. As a result, the reception acquisition unit 32 accepts the operation for the “RESERVE” button (step S91). When the user selects any resource from the list of movement destination resource displayed on the display 318, the reception acquisition unit 32 executes the movement operation to the selected resource. The movement operation may include newly reserving the selected resource and terminating the use of the resource currently in use (execution of leaving the room).

Subsequently, the transmitter/receiver 31 transmits a reservation request for the movement destination resource to the resource management server 5 (step S92). As a result, the transmitter/receiver 51 of the resource management server 5 receives the reservation request for the movement destination resource transmitted from the information processing terminal 3. At this time, the reservation request for the movement destination resource includes information related to the resource ID of the movement destination resource.

The transmitter/receiver 51 of the resource management server 5 that has received the reservation request for the movement destination resource from the information processing terminal 3 transmits the reservation request for the movement destination resource to the reservation management server 9 for reserving the movement destination resource (step S93). As a result, the transmitter/receiver 91 of the reservation management server 9 receives the reservation request for the movement destination resource transmitted from the resource management server 5. At this time, the reservation request for the movement destination resource includes information related to the resource ID of the movement destination.

The reservation information management unit 96 of the reservation management server 9 that has received the reservation request for the movement destination resource performs a new reservation processing for the resource indicated by the resource ID included in the received reservation request (step S94). As a result, new reservation information reserved by the reservation information management unit 96 is added to the reservation management table (the reservation management DB 9001, refer to FIG. 9). The new reservation information is, for example, each information corresponding to the reservation ID (E-005) of the reservation management table illustrated in FIG. 9.

The transmitter/receiver 91 of the reservation management server 9 with a reservation ID (E-005) that has made a new reservation transmits a reservation response for the movement destination resource to the resource management server 5 (step S95). As a result, the transmitter/receiver 51 of the resource management server 5 receives the reservation response for the movement destination resource transmitted by the reservation management server 9. At this time, the reservation response for the movement destination resource includes each information related to such as a newly reserved reservation ID (E-005), the reservation name, the resource ID, the resource name, the resource group, the reservation start date and time, the reservation end date and time, the number of participants, and the capacity.

Subsequently, the resource management unit 56 updates the reservation information management table (the reservation information management DB 5002, refer to FIG. 6) based on each information included in the reservation response for the movement destination resource transmitted by the reservation management server 9 (step S96). The content updated in this process is, as illustrated in FIG. 6, each information corresponding to the reservation ID (E-005) divided by the tenant ID (T-001) as a tab. Each information includes the reservation name (design meeting), the resource ID (R-002), the invitation code (0730), the operation rule ID (O-002), the reservation start date and time (2020/08/01 13:00), the reservation end date and time (2020/08/01 13:45), the number of participants (4) and the usage status (waiting for entry). Each information is additionally registered in the reservation information management table. That is, the reservation for the new resource indicated by the reservation ID (E-005) is made by taking over the reservation of the reservation ID (E-001).

After executing the new reservation process in step S96, the transmitter/receiver 51 transmits a request for changing the current reservation end date and time to the reservation management server 9 (step S97). As a result, the transmitter/receiver 91 of the reservation management server 9 receives the request for changing current reservation end date and time transmitted from the resource management server 5. At this time, the request for changing the current reservation end date and time includes the reservation ID (for example, E-001) related to the resource currently in use.

The reservation management server 9 that has received the request for changing the current reservation end date and time including the reservation ID (E-001) changes the reservation end date and time (step S98). Specifically, the reservation information management unit 96 and the storage/reading processing unit 99 change the reservation end date and time indicated by the reservation ID (E-001) to the current time on the reservation management table (the reservation management DB 9001, refer to FIG. 9)

After changing the reservation end date and time, the transmitter/receiver 91 transmits a response for changing the reservation end date and time to the resource management server 5 (step S99). As a result, the transmitter/receiver 51 of the resource management server 5 receives the response for changing the reservation end date and time transmitted from the reservation management server 9. The response for changing the reservation end date and time includes the reservation ID, the resource ID, the resource name, and the reservation end date and time. On the other hand, only the reservation ID may be received from the reservation management server 9 as transmitted to the reservation management server 9 in step S97.

Subsequently, the resource management unit 56 updates the reservation information in cooperation with the storage/reading processing unit 59 (step S100). Specifically, the resource management unit 56 and the storage/reading processing unit 59 update the reservation end date and time corresponding to the reservation ID received in step S99 on the reservation information management table (the reservation information management DB 5002, refer to FIG. 6).

After that, the transmitter/receiver 51 transmits an update notification of the reservation information to the information processing terminal 3 (step S101). As a result, the transmitter/receiver 31 of the information processing terminal 3 receives the update notification of the reservation information transmitted from the resource management server 5. At this time, the update notification of the reservation information includes the resource ID, the resource name, and updated reservation end date and time.

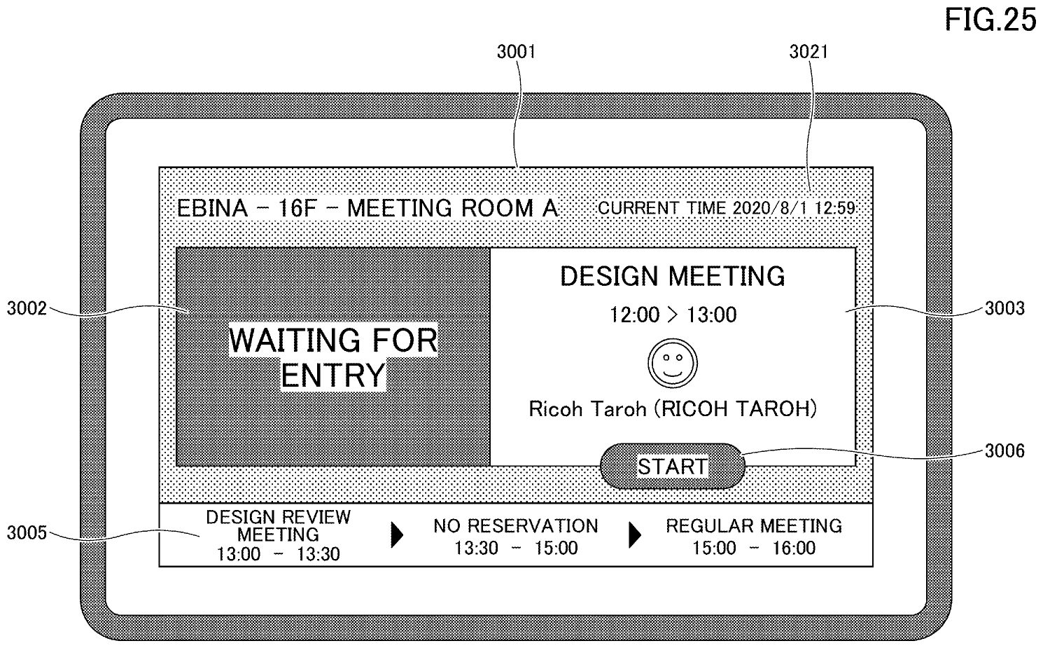

The display controller 34 of the information processing terminal 3 that received the update notification of the reservation information transmitted from the resource management server 5 displays a screen related to the new reservation illustrated in FIG. 25 on the display 318 of the information processing terminal 3 installed or arranged on the resource currently in use based on each information of the resource ID, the resource name, the reservation end date and time included in the update notification of reservation information (step S102). By executing each of the above-mentioned processing, the user can make the extension reservation of the current resource or the movement reservation accompanied by a movement to another resource, with the information processing terminal 3 installed or arranged in the resource.

<Example of Screen Display on Information Processing Terminal>

An example of a screen displayed on the information processing terminal 3 in each processing of FIG. 10 to FIG. 17 will be described with reference to FIG. 18 to FIG. 25.

(Vacancy Room Display)

FIG. 18 is a diagram illustrating an example of a vacancy room display screen of the information processing terminal according to the present embodiment. In FIG. 18, an entire area 3001, a usage status display area 3002, a reservation name display area 3003, an operation button 3004, the other reservation display area 3005, and a current time display area 3021 are provided. The following contents are displayed.

In the upper left part of the entire area 3001, “Ebina 16F—Meeting Room A” is displayed as the resource name currently used.

“VACANT” is displayed in the usage status display area 3002. In addition, in the reservation name display area 3003, “No reservation at 12:00 to 13:00” is displayed.

The operation button 3004 displays “USE NOW”, which is a state in which resources reservations by a user can be accepted.

In the other reservation display area 3005, at least one content indicating other reservation contents after 13:00 is displayed in chronological order.

In the current time display area 3021, the current time “2020/8/1 11:58” is displayed.

In the state of FIG. 18, the resource associated with the information processing terminal 3 is not reserved, and the resource may be available if any user operates the operation button 3004 displayed as “USE NOW” to make a reservation.

(Waiting for Entry Display)

FIG. 19 is a diagram illustrating an example of a waiting for entry display screen of the information processing terminal according to the present embodiment. This display screen is displayed, for example, by processing such as step S21 described previously. In FIG. 19, the same area as in FIG. 18 will not be described.

“WAITING FOR ENTRY” is displayed in the usage status display area 3002. Further, in the reservation name display area 3003, “DESIGN MEETING 12:00 to 13:00” is displayed. Also, the face photo and name of the reserved person or the user are also displayed.

“START” is displayed on the operation button 3006, which is in a state available of accepting the start operation or the room entry operation by the user.

(In Use/Extension Available Display)

FIG. 20 is a diagram illustrating an example of an extension display screen of the information processing terminal according to the present embodiment. This display screen is displayed, for example, by the processing of steps S29 and S49 described previously. In FIG. 20, the same area as in FIG. 18 will not be described.

“IN USE” is displayed in the usage status display area 3002.

“END” is displayed on the operation button 3007, which is in a state available of accepting the end operation or the exit operation by the user. Further, the operation button 3008 is displayed as “EXTENSION”, which is in a state available of accepting the resource extension operation by the user.

(Display During Extension)

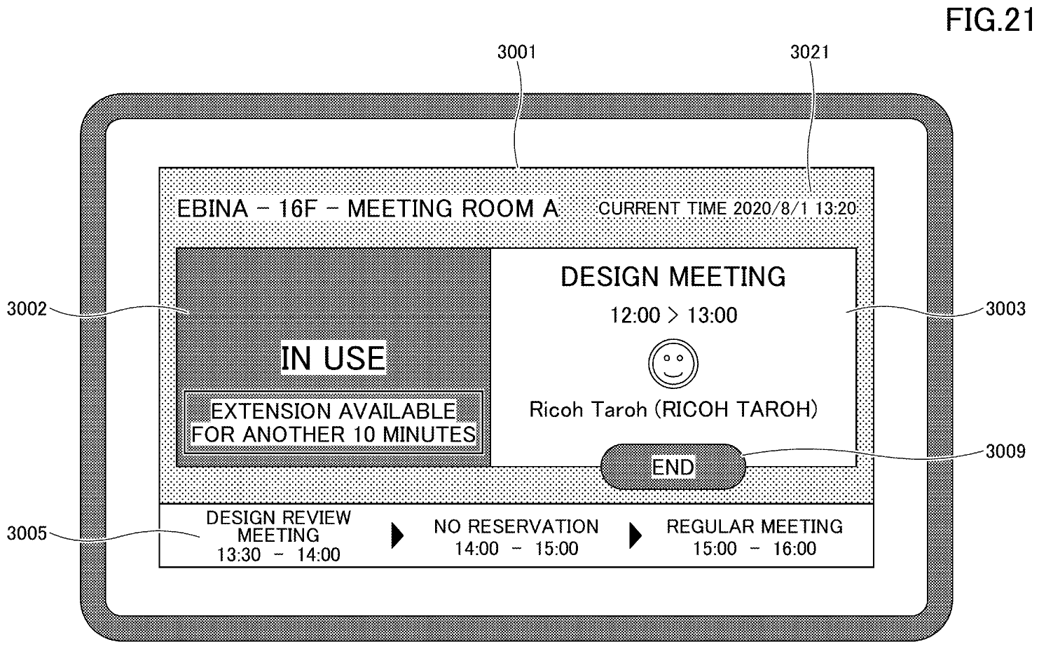

FIG. 21 is a diagram illustrating an example of a display screen during extension of the information processing terminal according to the present embodiment. This display screen is displayed, for example, in a predetermined period after the processing of step S49 described previously. In FIG. 21, the same area as in FIG. 18 will not be described.

At this time, “IN USE, EXTENSION AVAILABLE FOR ANOTHER 10 MINUTES” is displayed in the usage status display area 3002. In other words, since the current time is “2020/8/1 13:20” and the reservation after 13:30 (“Design Study Group 13:30-14:00)” is scheduled in the other reservation display area 3005, the resource can be extended by 10 minutes.

“END” is displayed on the operation button 3009, which is in a state available of accepting the end of the use of the resource by the user.

(In Use/Extension Not Available Display)

FIG. 22 is a diagram illustrating an example of a movement display screen of the information processing terminal according to the present embodiment. This display screen is displayed, for example, by the processing of steps S50 and S62 described previously. In FIG. 22, the same area as in FIG. 18 will not be described. In FIG. 22, only the display of the operation button 3010 (“MOVE” button) is different from FIG. 20. That is, while FIG. 20 is an example of a screen displayed on the information processing terminal 3 when the extension is available, FIG. 22 is an example of screen displayed on the information processing terminal 3 when the extension is not available.

(Display of When Multiple Movement Candidates Exist After Operating the “MOVE” Button)

FIG. 23 is a diagram illustrating an example of a candidate for movement destination display screen of the information processing terminal according to the present embodiment. This display screen is displayed, for example, by the processing of such as step S84 and step S85 described previously. In FIG. 23, the same area as in FIG. 18 will not be described.

A display area 3015 for the candidate resource for movement destination is displayed so as to cover the usage status display area 3002 and the reservation name display area 3003. Further, a list of candidate resource for movement destination, transmitted from the resource management server 5 in the processing of step S84 and step S85 described previously, is listed in the display area 3015 for the candidate resource for movement destination. In the present embodiment illustrates the case where the user selects candidate resource for movement destination at the top of the list to execute the reservation.

(Display of When No Movement Candidate Exists After Operating the “MOVE” Button)

FIG. 24 is a diagram illustrating an example of a display screen when there is no candidate for movement destination of the information processing terminal according to the present embodiment. For example, it is displayed in the processing of step S81 and step S82 described previously. In FIG. 24, the same area as in FIG. 18 will not be described.

The display area 3015 for no candidate resource for movement destination is displayed so as to cover the usage status display area 3002 and the reservation name display area 3003. A message indicating that a resource available of moving (meeting room) was not found and the OK button to be operated after confirming the message is displayed.

(Display of Waiting for Entry Related to Reservation of Other Resources)

FIG. 25 is a diagram illustrating an example of another waiting for entry display screen of the information processing terminal according to the present embodiment. This display screen is displayed, for example, by processing such as step S102 described previously. In FIG. 25, the same area as in FIG. 18 and FIG. 19 will not be described.

The difference between FIG. 25 and FIG. 19 is the content of the event displayed in the reservation name display area 3003.

In the reservation name display area 3003 of FIG. 25, “design review meeting 13:00 to 13:30” indicating the next reservation content is displayed. Also, the face photo and a name of the person who made the reservation at the design meeting or a person different from the user are displayed.

[Effects of Embodiment]

As described previously, according to the present embodiment, the determination unit 55 of the resource management server 5 executes a determination of reservation extension availability as to whether reserved resource can be extended and used (step S47), and the transmitter/receiver 51 transmits a response as a result of the determination of reservation extension availability to the information processing terminal 3 (step S48). The information processing terminal 3 that has received the response of the reservation extension “OK” from the resource management server 5 displays the “END” button and the “EXTENSION” button on the display 318 as in the screen example illustrated in FIG. 20 (step S49). On the other hand, the display controller 34 of the information processing terminal 3 that has received the response of the reservation extension “N/A” from the resource management server 5 displays the “END” button and the “MOVE” button on the display 318 as in the screen example illustrated in FIG. 22 (step S50).

This allows the user to extend the reserved resource and to reserve another resource with only operating the “EXTENSION” button or the “MOVE” button displayed corresponding to the result of the determination of reservation extension availability. As a result, the convenience when a user is making an extension reservation of the resource can be improved.

Further, since the display controller 34 of the information processing terminal 3 lists and displays the candidate resources for movement destination according to the basis (such as an order in which the location is close to the current resource, an order in which an extension time is long from the reservation end date and time (that is, an order in which an available time is long at the movement destination), an order of resources with an equipment similar to an equipment equipped in the resource currently in use, an order in which the capacity is large) on the display 318, the user can increase the degree of freedom in selecting the resource to be used.

[Other Application Examples]

Although the embodiments have been specifically described above, the present invention is not limited to the above-described embodiments. Variations and modifications may be made to the described subject matter without departing from the scope of the invention as set forth in the accompanying claims.

Further, each of the communication system 1 and the resource management system 7 described in the present embodiment also may be referred to as a web service. The web service includes a variety of services provided by applying an Internet-related technology. Examples of the web service include a meeting room rental service and other rental services. A system that uses the web service is referred to as a utilization system.

Further, the communication system 1 and the resource management system 7 described in the present embodiment may be divided into more processing units according to the process. Further, one processing unit can be divided to include a larger number of processes.

Further, each of the functions of the previously described embodiment may be implemented by one or more processing circuits or circuitry. As used herein, the “processing circuit” includes a processor programmed to perform each function by software, such as a processor implemented in electronic circuits, an application specific integrated circuit (ASIC) designed to perform each function as described above, a digital signal processor (DSP), a field programmable gate array (FPGA), or a conventional circuit module.

What is claimed is:

1. A resource management apparatus managing a resource, the resource management apparatus comprising:
one or more memories; and
one or more processing circuits coupled to the one or more memories and configured to function as:
a receiver configured to receive reservation information related to a reservation of a resource transmitted by a reservation management device managing the reservation of the resource; and
a transmitter configured to transmit predetermined reservation information, which is updated for a reservation of a predetermined resource, to an information processing terminal operated by a user of the predetermined resource;
wherein upon determination that the predetermined resource is available for continued reservation beyond a reservation end date and time of the predetermined resource currently in use, the transmitter transmits, to the information processing terminal, extension selection information for prompting a selection of whether to extend a use of the predetermined resource,
wherein upon determination that the predetermined resource is not available for continued reservation beyond the reservation end date and time, the transmitter transmits, to the information processing terminal, movement selection information for prompting a selection of whether to move from the predetermined resource to another resource,
wherein the determination that the predetermined resource is available and the determination that the predetermined resource is not available are made based on a reservation status following the reservation end date and time obtained by comparing the reservation information received by the receiver with reservation end date and time information indicating the reservation end date and time of the predetermined resource currently in use.

2. The resource management apparatus according to claim 1, wherein the transmitter transmits the extension selection information or the movement selection information to the information processing terminal, after a predetermined time from a reservation start date and time of the predetermined resource elapses.

3. The resource management apparatus according to claim 2, wherein the predetermined time is any time between the reservation start date and time of the predetermined resource and the reservation end date and time of the predetermined resource.

4. The resource management apparatus according to claim 1, wherein the transmitter transmits a list of newly available resources that the information processing terminal is capable of using, when operation information, for moving of the information processing terminal that received the movement selection information from the predetermined resource currently in use to another resource, is received by the receiver.

5. The resource management apparatus according to claim 4, wherein the transmitter transmits the list of newly available resources for the information processing terminal according to an order in which a location is close to the predetermined resource currently in use, an order in which an extension time is long, or an order in which a capacity is large.

6. The resource management apparatus according to claim 1, further comprising a determination unit configured to obtain a reservation status beyond the reservation end date and time by comparing the reservation information received by the receiver with the reservation end date and time information indicating the reservation end date and time of the predetermined resource currently in use,
wherein the determination unit determines whether a movement from the predetermined resource to another resource is available when the predetermined resource unavailable for a continuous reservation.

7. A resource management system comprising:
one or more memories; and
one or more processing circuits coupled to the one or more memories and configured to function as:
a resource management apparatus managing a resource, and
an information processing terminal displaying a usage status of the resource,
the resource management apparatus comprising:
a receiver configured to receive reservation information related to a reservation of a resource transmitted by a reservation management device managing the reservation of the resource; and
a transmitter configured to transmit predetermined reservation information updated for a reservation of a predetermined resource to an information processing terminal operated by a user of the predetermined resource,
wherein upon determination that the predetermined resource is available for continued reservation beyond a reservation end date and time of the predetermined resource currently in use, the transmitter transmits, to the information processing terminal, extension selection information for prompting a selection of whether to extend a use of the predetermined resource,
wherein upon determination that the predetermined resource is not available for continued reservation beyond a reservation end date and time of the predetermined resource currently in use, the transmitter transmits, to the information processing terminal, movement selection information for prompting a selection of whether to move from the predetermined resource to another resource,
wherein the determination that the predetermined resource is available and the determination that the predetermined resource is not available are made based on a reservation status following the reservation end date and time obtained by comparing the reservation information received by the receiver with information indicating the reservation end date and time.

8. The resource management system according to claim 7, wherein the information processing terminal further comprises
an information receiver configured to receive the extension selection information and the movement selection information transmitted by the resource management device; and
a display controller configured to display on a display unit an extension selection unit generated based on the extension selection information or a movement selection unit generated based on the movement selection information,
wherein, when the extension selection unit is operated by the user, the display controller displays, on the display unit, another resource being a candidate for a destination of the movement, with an order in which a location is close to the predetermined resource currently in use, an order in which an extension time is long from the reservation end date and time, an order of resources with equipment similar to an equipment equipped in the resource currently in use, or an order in which a capacity is large.

9. A non-transitory recording medium storing a program to cause a computer to function as the receiver and the transmitter according to claim 1.
